(19) United States
(12) Patent Application Publication
(10) Pub. No.: US 2026/0134644 A1
(43) Pub. Date: May 14, 2026

(54) IN-EXPERIENCE CREATION

(71) Applicant: Roblox Corporation, San Mateo, CA (US)

(72) Inventors: Foad DABIRI, Redwood City, CA (US); Faraz BAGHERNEZHAD, Redwood City, CA (US); Shailendra RATHORE, San Ramon, CA (US); Mahardiansyah KARTIKA, Newark, CA (US); Brandon COHEN, San Mateo, CA (US); Conor GRIFFIN, San Mateo, CA (US); Charles KUBAL, San Francisco, CA (US)

(73) Assignee: Roblox Corporation, San Mateo, CA (US)

(21) Appl. No.: 19/174,679

(22) Filed: Apr. 9, 2025

Related U.S. Application Data
(60) Provisional application No. 63/720,613, filed on Nov. 14, 2024.

(51) Int. Cl. G06T 19/20; G06Q 20/12

(52) U.S. Cl. CPC G06T 19/20; G06Q 20/123; G06T 2200/24; G06T 2219/2021

(57) ABSTRACT

A token providing access to a modifiable asset in a virtual environment is provided. A request to create the token is received, the request comprising asset type and pricing information. The token is generated based on the request and linked to the modifiable asset in a particular virtual experience. The token is provided for purchase. A purchase request for the token is received from a user account of the virtual experience, and the user account is provided with the token. The user creates a variant of the modifiable asset using a user interface while maintaining an asset type of the modifiable asset. After the variant is created, the variant is stored in an inventory of the user account. After storing the variant of the modifiable asset, an avatar associated with the user is optionally equipped with the variant of the modifiable asset.

### CROSS-REFERENCE TO RELATED APPLICATIONS

This application claims priority to U.S. Provisional Application No. 63/720,613, entitled “IN-EXPERIENCE CREATION,” filed on Nov. 14, 2024, the content of which is incorporated herein in its entirety.

### TECHNICAL FIELD

This disclosure relates generally to entities in virtual environments, and more particularly but not exclusively, relates to methods, systems, and computer-readable media to provide an improvement to managing user-generated content (UGC), for example, by enabling users to create net-new avatar bodies, heads, faces, and other modifiable assets from inside experiences.

### BACKGROUND

In a virtual environment, users may wish to generate their own user-generated content (UGC). Such content may include new avatar bodies, heads/faces, accessories, and clothing from inside experiences. At present, there is no way in virtual environments to provide a user with a single point of access to an asset that permits the user to purchase the asset in one transaction and thereafter have the freedom to create variants of the asset without additional expenditures.

Some implementations were conceived in light of the above.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

According to one aspect, a computer-implemented method to create a token that provides access to a modifiable asset usable in a virtual environment is provided, the method comprising: receiving a request to create the token, the request comprising asset type information and pricing information for the token; in response to the request, generating the token, the token being associated with a particular virtual experience in the virtual environment, and comprising a token identifier, a product price that matches the pricing information in the request, and an asset type that matches the asset type information in the request; linking the token with the modifiable asset in the particular virtual experience using the token identifier; providing the token for purchase in the particular virtual experience; receiving a purchase request for the token from a user account associated with an avatar in the particular virtual experience; providing the token to the user account; allowing a user associated with the user account to create a variant of the modifiable asset usable in the particular virtual experience using a user interface while maintaining the asset type associated with the token, wherein the modifiable asset is accessed using the token identifier; and storing the variant of the modifiable asset to an inventory of the user account associated with the particular virtual experience, wherein after the storing the variant of the modifiable asset, the user associated with the user account is provided with an option to equip the avatar associated with the user with the variant of the modifiable asset.

Various implementations of the computer-implemented method are described herein.

In some implementations, the user interface includes one or both of a dynamic texture interface and a dynamic mesh interface that make temporary modifications to the variant of the modifiable asset and the temporary modifications are made permanent when the variant of the modifiable asset is stored.

In some implementations, the token is further associated with a creator permissions entity that defines access privileges associated with the token for the user account that makes the purchase request for the token, the access privileges specifying permissions for the user to alter the modifiable asset when creating the variant of the modifiable asset.

In some implementations, the computer-implemented method further comprises performing moderation on the variant of the modifiable asset before the variant of the modifiable asset is stored to generate a moderation success or a moderation failure.

In some implementations, if the moderation failure is generated, the virtual environment reverts to a last state before storage.

In some implementations, if the moderation failure is generated, storing of the variant of the modifiable asset is omitted.

In some implementations, storing the variant of the modifiable asset is in response to generating the moderation success.

In some implementations, the computer-implemented method further comprises validating the modifiable asset using a schema for the asset type of the token before storing the variant of the modifiable asset.

In some implementations, allowing the user to create the variant of the modifiable asset comprises permitting the user to create an arbitrary number of variants of the modifiable asset.

According to another aspect, a non-transitory computer-readable medium is provided. The non-transitory computer-readable medium has instructions stored thereon that, responsive to execution by a processing device, causes the processing device to perform a computer-implemented method comprising: receiving a request to create a token that provides access to a modifiable asset usable in a virtual environment, the request comprising asset type information and pricing information for the token; in response to the request, generating the token, the token being associated with a particular virtual experience in the virtual environment, and comprising a token identifier, a product price that matches the pricing information in the request, and an asset type that matches the asset type information in the request; linking the token with the modifiable asset in the particular virtual experience using the token identifier; providing the token for purchase the particular virtual experience; receiving a purchase request for the token from a user account associated with an avatar in the particular virtual experience; providing the token to the user account; allowing a user associated with the user account to create a variant of the modifiable asset usable in the particular virtual experience using a user interface while maintaining the asset type associated with the token, wherein the modifiable asset is accessed using the token identifier; and storing the variant of the modifiable asset to an inventory of the user account associated with the particular virtual experience, wherein after the storing the variant of the modifiable asset, the user associated with the user account is provided with an option to equip the avatar associated with the user with the variant of the modifiable asset.

Various implementations of the non-transitory computer-readable medium are described herein.

In some implementations, the user interface includes one or both of a dynamic texture interface and a dynamic mesh interface that make temporary modifications to the variant of the modifiable asset and the temporary modifications are made permanent when the variant of the modifiable asset is stored.

In some implementations, the token is further associated with a creator permissions entity that defines access privileges associated with the token for the user account that makes the purchase request for the token, the access privileges specifying permissions for the user to alter the modifiable asset when creating the variant of the modifiable asset.

In some implementations, the instructions cause the processing device to perform further operations comprising performing moderation on the variant of the modifiable asset before the variant of the modifiable asset is stored to generate a moderation success or a moderation failure.

In some implementations, the instructions cause the processing device to perform further operations comprising validating the modifiable asset using a schema for the asset type of the token before storing the variant of the modifiable asset.

In some implementations, allowing the user to create the variant of the modifiable asset comprises permitting the user to create an arbitrary number of variants of the modifiable asset.

According to another aspect, a system is disclosed, comprising: a memory with instructions stored thereon; and a processing device, coupled to the memory, the processing device configured to access the memory and execute the instructions, wherein the instructions cause the processing device to perform a computer-implemented method comprising: receiving a request to create a token that provides access to a modifiable asset usable in a virtual environment, the request comprising asset type information and pricing information for the token; in response to the request, generating the token, the token being associated with a particular virtual experience in the virtual environment, and comprising a token identifier, a product price that matches the pricing information in the request, and an asset type that matches the asset type information in the request; linking the token with the modifiable asset in the particular virtual experience using the token identifier; providing the token for purchase in the particular virtual experience; receiving a purchase request for the token from a user account associated with an avatar in the particular virtual experience; providing the token to the user account; allowing a user associated with the user account to create a variant of the modifiable asset usable in the particular virtual experience using a user interface while maintaining the asset type associated with the token, wherein the modifiable asset is accessed using the token identifier; and storing the variant of the modifiable asset to an inventory of the user account associated with the particular virtual experience, wherein after the storing the variant of the modifiable asset, the user associated with the user account is provided with an option to equip the avatar associated with the user with the variant of the modifiable asset.

Various implementations of the system are described herein.

In some implementations, the user interface includes one or both of a dynamic texture interface and a dynamic mesh interface that make temporary modifications to the variant of the modifiable asset and the temporary modifications are made permanent when the variant of the modifiable asset is stored.

In some implementations, the token is further associated with a creator permissions entity that defines access privileges associated with the token for the user account that makes the purchase request for the token, the access privileges specifying permissions for the user to alter the modifiable asset when creating the variant of the modifiable asset.

In some implementations, the instructions cause the processing device to perform further operations comprising performing moderation on the variant of the modifiable asset before the variant of the modifiable asset is stored to generate a moderation success or a moderation failure.

In some implementations, the instructions cause the processing device to perform further operations comprising validating the modifiable asset using a schema for the asset type of the token before storing the variant of the modifiable asset.

In some implementations, allowing the user to create the variant of the modifiable asset comprises permitting the user to create an arbitrary number of variants of the modifiable asset.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF THE DRAWINGS

FIG. 1 is a diagram illustrating an example of using a development environment to generate asset variants for sale in a virtual environment, in accordance with some implementations.

FIG. 2 is a diagram illustrating an example of a developer using a creator dashboard to create a token to manage a modifiable asset, in accordance with some implementations.

FIG. 3 is a diagram illustrating an example of using a token in a virtual environment to create asset variants, in accordance with some implementations.

FIG. 4 is a diagram illustrating an example of generating a token, in accordance with some implementations.

FIG. 5 is a diagram illustrating an example of receiving and using a token, in accordance with some implementations.

FIG. 6A illustrates a flowchart of an example computer-implemented method to create and provide a token, in accordance with some implementations.

FIG. 6B illustrates a flowchart of an example computer-implemented method to sell and provide a token and use the token to create a variant of an asset, in accordance with some implementations.

FIG. 7 illustrates a flowchart of an example computer-implemented method to perform moderation on a created asset, in accordance with some implementations.

FIG. 8 illustrates a diagram of creating and providing a token in a virtual experience, in accordance with some implementations.

FIG. 9 illustrates a diagram of operations performed by a user to modify and use a modifiable asset, in accordance with some implementations.

FIG. 10 illustrates a flowchart of an example computer-implemented method to perform moderation on a created asset, in accordance with some implementations.

FIG. 11 illustrates a flowchart of an example computer-implemented method performed by a developer to create and provide a token to manage a modifiable asset, in accordance with some implementations.

FIG. 12 illustrates a flowchart of an example computer-implemented method to use a token to manage a modifiable asset, in accordance with some implementations.

FIG. 13 illustrates a diagram of operations performed by a developer to create and provide a token and corresponding token instances, in accordance with some implementations.

FIG. 14 illustrates a diagram of operations to provide in-experience creation capabilities, in accordance with some implementations.

FIG. 15 is a diagram of an example system architecture that provides a token to manage modifiable assets, in accordance with some implementations.

FIG. 16 is a block diagram that illustrates an example computing device which may be used to implement one or more features described herein, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “one implementation,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

Implementations of the present disclosure relate to techniques of generating a token that provides access to a modifiable asset usable in a virtual environment. The techniques include creating such a token at the instruction and/or request of a developer. The token is provided for purchase by the users of the virtual environment. Once purchased, the token permits the purchasing user to create variants of the modifiable asset.

Generating such a token, providing the token for purchase, and using the token once purchased has certain advantages. Rather than specifying that every variant of an asset be constructed and then purchased separately, it becomes possible for users to purchase a token and use the token to make their experience intuitive and user-friendly. Specifically, users may purchase a single token and then the token permits the user to make multiple variants of the modifiable asset. This simplifies variant creation and also reduces computational and monetary costs. Usage of other technical resources, such as memory usage and storage usage, may also be reduced using this approach.

Moreover, this approach is helpful to developers, who may create a single token, configure the token, and then use that token to sell an asset and a family of variants. Hence, using a token avoids the use of multiple transactions associated with variants that vary slightly, streamlining the experience for both the developer and the user. Operating in this manner makes payments between the developer, the user, and the virtual environment work better as well.

For example, the developer generates a token associated with a modifiable asset, such as a body. A user purchases the token, and the token permits the user to create variants of the modifiable asset. Creating the variants may include a dynamic texture interface, a dynamic mesh interface, or a combination thereof. However, a dynamic texture interface and a dynamic mesh interface are only examples of ways to create the variants, and other user interfaces may be used in some implementations to allow the user to create the variants. The variants may be stored in and/or associated with the inventory of the user, and optionally equipped.

There may be a dynamic texture interface that allows a user to modify texture(s) associated with the modifiable asset. There may also be a dynamic mesh interface that allows a user to modify mesh(es) associated with the modifiable asset. For example, these interfaces may be provided by the virtual environment or by a virtual experience within the virtual environment. The interfaces may include various graphical user interface (GUI) elements or other interface elements that allow a user to provide input to change the modifiable asset. The dynamic texture interface and the dynamic mesh interface may make temporary modifications to the variant of the modifiable asset, which may be made permanent when the variant of the modifiable asset is stored. While a dynamic texture interface and a dynamic mesh interface are examples of interfaces used to modify the modifiable asset, other interfaces are possible that would modify other properties of the modifiable asset. The token may also be associated with access privileges that govern how the token may be used to modify the modifiable asset.

When creating the variants of the modifiable asset, the modifiable asset may undergo moderation to confirm that the variants conform with certain content policies. Depending on the moderation results, the modifiable asset may be stored or the changes may be ignored and/or undone. There also may be a validation performed using a schema to check the format and/or structure of the modifiable assets.

Implementations of the present disclosure also relate to techniques of facilitating the creation and sale of assets in a virtual environment. It is potentially helpful to permit user-generated content (UGC) creation in a virtual environment. Hence, it may be helpful to enable UGC content creation by enabling users to create net-new avatar bodies and heads/bodies from inside an experience. There are various aspects of enabling such capabilities. The UGC may include modifications to existing approaches for a publishing flow, the triggering of the creation of new assets/bundles, and to how content is updated and stored after creation and user edits.

In a virtual environment, users may wish to generate their own user-generated content (UGC). Such content may include new avatar bodies, heads/faces, and accessories and clothing from inside experiences. At present, there is no way in virtual environments to provide a user with a single point of access to an asset that permits the user to purchase the asset in one transaction and thereafter have the freedom to create variants of the asset without additional expenditures.

To address these issues, it may be helpful to add capabilities to the virtual environment that may permit a user to purchase rights to a modifiable asset in a specific virtual experience. The user may then take the modifiable asset and use the modifiable asset as the basis of asset variants that may make various alterations to the modifiable asset while retaining the asset type of the modifiable asset.

As a solution to facilitate creating, selling, and modifying assets in a virtual environment, a new structure referred to as a token is created. Such a token may help manage creating a new entity or system specifically designed for managing creator authorizations within experiences.

The token may include features such as a creator permissions entity, which may be a new entity specifically for managing creator permissions within experiences, such as with fields for access levels, editing rights, etc. The token may interact with APIs and integrations by developing APIs that permit experiences to query and interact with the creator permissions entity, enabling dynamic control over who can build and edit within a given experience.

There may also be a user interface for creators, creating a clear and intuitive user interface with a virtual creation environment application or web portal to permit creators to manage their permissions and access levels. By creating a dedicated system and architecture for these new features, it may be possible to ensure clarity, flexibility, and scalability, thereby providing a smoother experience for both creators and users in a virtual marketplace of the virtual environment.

Using tokens in this manner facilitates In-Experience Creation (by using manual or Generative Artificial Intelligence (AI) techniques), permitting users to create bodies, heads, and accessories and clothing within an experience, modify these assets using various tools, and to save them to their inventories.

Bundles are a concept in a marketplace (MP) designed to sell a collection of assets, often utilized for user-generated content (UGC) bodies. While bundles align with some aspects of the In-Experience Creation (IEC) use case, there are limitations on bundles. For instance, in IEC scenarios like a photo-to-avatar scenario (i.e., where a product is to be created without initial assets as a basis) bundles do not fit well. Furthermore, incorporating bundles may add unnecessary complexity to modeling, as a base body is not a prerequisite.

Introducing an alternative concept of tokens, a solution is proposed in some implementations to map different products and enable developers to purchase creation rights. This concept of tokens bears some resemblance to game passes or developer products. Implementing tokens involves the establishment of a new entity and infrastructure to support it, and such implementation involves appropriate design and planning.

A token may represent a unique product (or family of products). For example, there can be a body token, a photo-to-avatar token, a shirt token, etc.

Existing bundles cannot be used as tokens for several reasons. Bundles have a different purpose in that bundles are designed for collections of items rather than variants of the same item. Bundles are not well-suited to manage permissions and access control. Bundles are not well-designed for managing permissions complexity and scalability. Using bundles in a manner similar tokens (instead of the tokens discussed herein) may provide a confusing user experience and have limited expansion and flexibility operations, as well as other drawbacks.

Hence, there may be a token specifically designed to aid in producing user-generated content (UGC). As discussed herein, such tokens may provide a creator permissions entity, APIs and integrations, and a user interface for creators, thereby facilitating the use of modifiable assets in conjunction with a virtual experience and the creation, storage, moderation, and management of the same. By providing these capabilities, using tokens allows generation and modification of modifiable assets in a way that requires fewer computing resources while improving the user experience.

Certain terminology is used in the present disclosure. The term “net-new” refers to a new asset and/or bundle represented by a new, unique asset ID/bundle ID in a backend system. Often this pertains to the result of a “publish (creator context)” step. The term “publish (Economy context)” denotes to list a piece of content on an online marketplace, such as an avatar marketplace. The term “push to Inventory” denotes for a user to create avatar content (portable across a platform) and add to the avatar content to the own inventory of that user. Such content is not available for sale on the online marketplace.

The term “publish (Creator context)” denotes for a user to upload a piece of content to the virtual environment and generate a new asset ID for the content. The term “outfit” refers to a group of avatar items (including bodies/heads) that can be worn. The term “bundle” refers to a group of avatar items that can be sold. Such a bundle can include an outfit or 10 pairs of shoes lumped together. The term “avatar asset” refers to one of the explicit component assets of an avatar (e.g., Left Leg or Hat). The term “avatar accessories” refers to the subset of avatar assets that can be worn, for example, hats, shirts, pants, etc.

The term “avatar content” refers to any avatar-related construct that an end user can interact with. Inclusive of avatar assets, outfits, and bundles. The term “body” refers to a humanoid consisting of one of each fundamental part of an avatar. If not specified, this is inclusive of a head. The term “remixability” refers to concept of a creator permitting an avatar asset to be modified (at the vertex/texture level) by anyone who owns it.

Some implementations may operate based on certain assumptions. For example, any content present in runtime memory can be submitted to in-experience publication Application Programming Interfaces (APIs) and be treated as valid if the content passes necessary validations.

Implementations do not always rely on developers submitting Bodies/Heads/Clothing in advance of publishing their experiences. There may be instances where a developer may use an insertion service for an avatar body or asset the developer has created and submitted to moderation already. In those instances, a virtual environment may grant assets that do not have dynamic textures/meshes. Eyebrows and Eyelashes are a good example of where this granting is possibly appropriate. This approach also follows a logic of subsequent edits made to items pushed to Inventory.

Textures and Meshes may support versioning on the backend. This also affects a Data Model (DM) as the DM is to store and manage versions.

Dynamic Textures and Dynamic Meshes are examples of in-memory canvases for editing content. Dynamic Textures and Dynamic Meshes become regular textures and meshes upon publication. To permit users to edit Meshes and Textures that have already been pushed to a platform, developers may load a specific asset ID into a dynamic data structure at runtime. It may be possible to handle the conversion from dynamic data structure to Mesh/Texture on publication.

Heads and bodies may follow a consistent logic that is easy for users to understand. There may not be a special case based on the origination of the asset (e.g., a virtual environment creation program, in-experience, digital content creation (DCC), etc.). This consistency provides simplicity for the end-user. There may be a single publication flow and payment for a body and/or for a head. Users may not have to click to publish limbs, then torso, or individual assets.

In some implementations, there may be a single payment for access to the full body and the relevant variants. At launch (e.g., at the launch of this feature in the virtual environment), bodies and heads may be priced at a minimum of a floor price for IEC bodies (determined by the virtual environment) plus a moderation fee (also determined by the virtual environment). By using a single payment, it is possible to purchase a token that manages access to a modifiable asset in a way that uses computing resources more efficiently.

The avatar content is attributed to the experience in which the avatar content was generated. The avatar content may involve attribution back to the Universe ID in which the avatar content was created, which deeplinks to the creation portion of that experience. Assets and outfits can be modified from the experience in which the assets and outfits were created. For example, mesh and texture editing of an asset may be confined to the original experience for the original creator.

When an asset is an avatar asset, a developer may not be able to publish an asset that was made in one experience and then enter another experience and modify the texture or mesh of that asset. Similarly, bodies can be pushed to a corresponding inventory if the underlying assets were created in that experience or granted by that experience. Associating assets with a particular experience may help ensure that only users with appropriate access privileges can access and/or modify a given asset.

It may be relevant to proper operation of some implementations to validate that users are being granted assets the users are permitted to be granted (owned by the experience creator or free assets in the virtual environment). As part of this flow for publishing bodies and assets together, users may not be able create new bundles of assets that are just in their inventory in an experience and push them to inventory, created in other experiences, or otherwise do not match the conditions above.

Alternatively, there may be a developer option to opt out of this condition and not permit the component parts of an outfit to be swapped at the platform and in other editors (e.g., create a dinosaur and not permit the limbs to be swapped).

When publishing a new body, it may not be appropriate for the user to show up as a naked body (with modesty layer) in-experience. It may be helpful to enable switching bodies without losing the clothing currently equipped ongoing as well. A new outfit type, Body, is created that is the Body outfit (Head outfit+limbs, torso). When equipping the outfit, users swap out their existing Body but retain the clothing and accessories the users have equipped.

This new outfit type may be created before the outfit type is implemented in the avatar editor but is built out so that bodies pushed to inventory are consistent long-term. As another factor, to make sure the systems do not become overloaded from a single user or group mass publishing bodies, there may be a rate limit for body publishing to ten bodies published from in-experience per day (as an arbitrary example), across the experiences (the total may be the sum of bodies across any experience, not per experience). The limit may have a different value than ten, which is merely a non-limiting example.

In some implementations, net-new outfits and assets are created when the new outfits and assets are changed on publication and grant for existing assets that are unchanged. However, versioning may be present in other implementations. It may also be helpful to provide users with tools to archive assets and remove outfits from the avatar editor.

When a bundle is in moderation, the user has the assets/outfit equipped that the user had before the creation process. Upon passing moderation, the developer may be notified, and the developer can send a notification asking if the user would like to equip the new body outfit and assets. There may be a shared liability model to manage moderation. Users are also partially responsible for moderation decisions, and may be able to appeal if their item fails moderation.

In the case that an item fails moderation, the user receives a refund (optionally minus any moderation fee), and the developer does not receive a developer portion of a payout for the purchase in-experience. Developers are responsible if their experience generates a lot of bad content. In the case of an experience that generates a lot of bad content and such an experience is detected by the virtual environment, the virtual environment may flag when a low percentage of submissions are passing moderation and take necessary action against that experience, as determined by trust and safety (T and S) and policy enforcement.

It may be problematic if many bad bodies get through moderation and this is realized once a large number (e.g., 100,000) of offensive bodies are already in inventories. To address this situation, it may be possible to leverage techniques to identify item similarity to identify and take down bodies that are similar to the offending one. Such an approach helps automate and facilitate moderation while minimizing user involvement.

In some implementations, individual assets are moderated with a lightweight machine learning (ML) model, then the composite Body is moderated with a heavyweight machine learning (ML) model. A lightweight ML model refers to a smaller, less complex model that uses fewer computational resources to run. A heavyweight ML model refers to a larger, more complex model that has higher accuracy but needs more computational resources to run. If an asset is rejected (e.g., a left leg), the outfit and the assets are rejected. If the assets pass but the composite body fails moderation, the assets and the outfit are also rejected. This approach provides that in some implementations a rejection may occur up and down the tree, to avoid assets with moderation problems. It may be acceptable to have some false positives and to avoid pushing partial bodies (i.e., torso and left arm, left leg) to a user inventory. Such an approach errs on the side of caution.

There are a number of errors that can occur during an attempt by a user to publish a modifiable asset, and these may be communicated to the user. Since the virtual environment does not control the creation flow within the experience, there may be a backend API that tells the developer if the user is eligible to push to an inventory (and how many submission attempts the user has left that day, if a limit to submissions is in place). It may be helpful to communicate errors to the user as soon as the virtual environment is aware of them. There are at least three stages at which errors can be communicated to a user.

As a first stage, when the user taps in the experience to enter metadata and the Submit Creation pop-up is launched. As a second stage, when the user taps (or otherwise invokes) the call to action (CTA) in the Submit Creation pop-up. As a third stage, after moderation has been completed.

For example, post-creation, tapping to enter metadata, errors may include that the user does not have permission to publish, there are too many publishes (e.g., greater than ten publication attempts in a twenty-four hour period), or that connection was lost and upload failed. Alternatively, an automated detection may occurs, such as when trying to push to inventory from submission pop-up, errors may include not enough of an appropriate currency, a text filter violation, validation failed (e.g. portions not rigged, body parts missing, body scale (too big/small per body part, overall body), body disconnected, transparency/invisible parts, ownership issue (e.g., trying to publish a limb that is not the limb of the experience owner)), a connection lost/upload failed error, or an item similarity error (body too similar to a paid virtual environment first party body).

An error after moderation has been completed may include an item similarity error (body too similar to a paid virtual environment first party body), a failed moderation (notification in-experience and in the virtual environment, such as in a tray of tools), a too much clothing error (e.g., includes presence of tattoos and makeup - anything directly situated on a body that may be a separate avatar asset), or no modesty layer (where a modesty layer refers to a portion of an avatar that a virtual environment may require to be clothed to avoid inappropriate content). Some of these errors may be appealable. For example, for some modifiable assets it may be appropriate to override the no modesty layer error.

There may be a number of additional features present in some implementations. These additional features may include notifications of moderation results, which may be provided to users through various channels. Another additional feature is a developer-set publication fee, where the developer is able to choose the price of a modifiable asset and its associated token. Yet another additional feature is archiving, which is a feature that permits archiving and/or hiding of various revisions to modifiable assets, such as at an avatar editor, that hide assets without deleting them to make interactions easier.

Another additional feature may be enhanced versioning, which may manage and store different versions of assets separately. Still another additional feature is supporting mood, eyebrow, and eyelashes publishing as asset types. Another additional aspect may be non-swappable body parts. Another additional feature may be additional optional body part assets, such as mustaches and beards, that may not be present in every avatar. Another additional aspect may be asset remixability, where creators may permit their assets to be remixable, such that the texture may be modified or the mesh deformed, even without using a token as discussed herein.

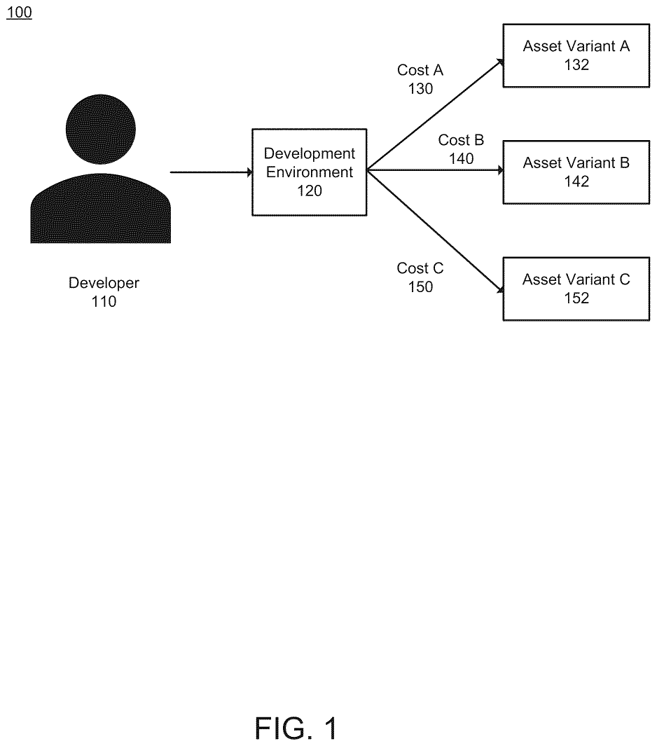

FIG. 1 is a diagram 100 illustrating an example of a development environment configured to generate asset variants for sale in a virtual environment, in accordance with some implementations. FIG. 1 and the other figures use like reference numerals to identify similar elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

FIG. 1 illustrates a developer 110. The developer 110 interacts with a development environment 120. In the example of FIG. 1, developer 110 uses development environment 120.

Specifically, developer 101 creates asset variant A 132 for a cost A 130. Developer 101 creates asset variant B 142 for a cost B 140. Developer 101 creates asset variant C 152 for a cost C 150. FIG. 1 illustrates an approach in which developer 101 is only able to create provide variants as separate transactions. These costs may be levied in various currencies, such as an in-game currency, a national currency (e.g., U.S. dollars, Japanese yen, European Union euros, etc.), or a cryptocurrency.

The approach of FIG. 1 can become cumbersome. For example, a creator creates multiple shoes with the objective of selecting each shoe separately in the marketplace. Accordingly, the creator and the user have to pay separately for each variant, even if the variants are very similar to one another. Additionally, this involves inefficient use of resources due to redundancy.

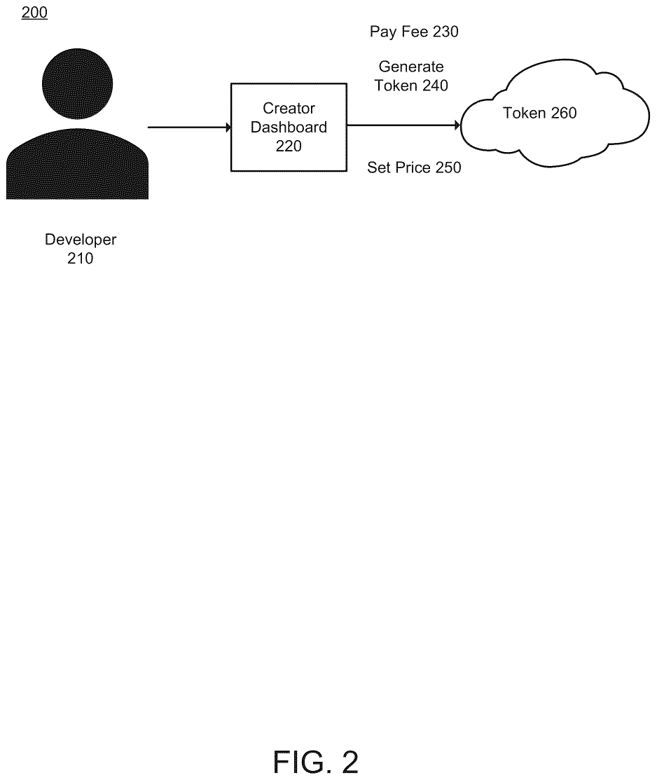

FIG. 2 is a diagram 200 illustrating an example of a developer using a creator dashboard to create a token to manage a modifiable asset, in accordance with some implementations. Developer 210 interacts with creator dashboard 220. Here, a creator dashboard 220 may correspond to an interface that allows developer 210 to perform creative tasks in the context of a virtual experience in a virtual environment. Creator dashboard 220 receives a request from the developer 210 to create the token. For example, the developer 210 pays a fee at 230 for the token and sets a price at 250 for the token. Based on receiving the developer fee and setting the price, a generate token operation occurs at 240, providing a token 260. An example of using such a token 260 is presented herein.

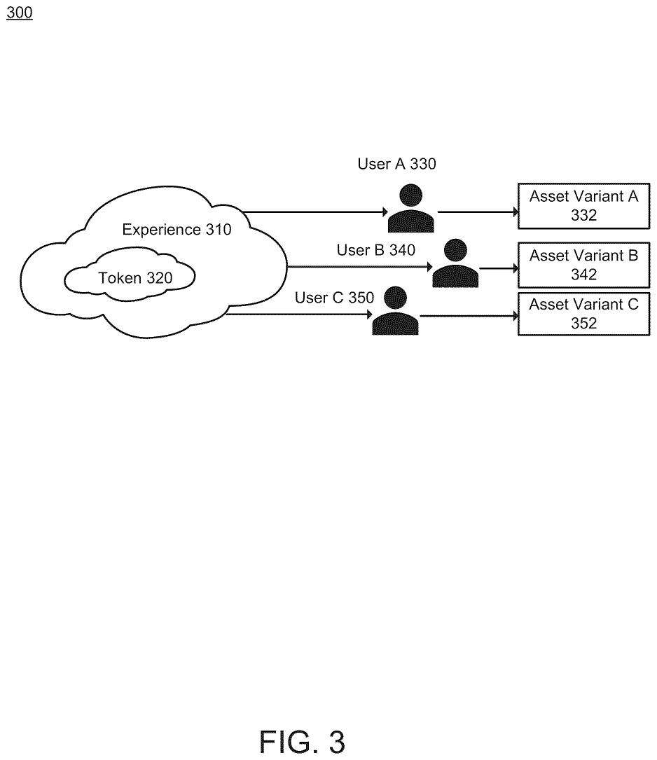

FIG. 3 is a diagram 300 illustrating an example of using a token in a virtual environment to create asset variants, in accordance with some implementations. FIG. 3 illustrates an experience 310. Experience 310 may be associated with a token 320. Token 320 is a token 320 similar to token 260 that can allow modification of a modifiable asset in a particular virtual environment.

The token 320 can permit user A 330 to generate asset variant A 332, user B 340 to generate asset variant B 342, and user C 350 to generate asset variant C 352. As illustrated in FIGS. 2-3, in in-experience creation (IEC) the developer 210 pays a one-time fee for the token 260 (such as a token associated with a shoe). The users (e.g., user A 330, user B 340, and user C 350) purchase the token 320 and can then create variants (e.g., asset variant A 332, asset variant B 342, and asset variant C 352). The approach of FIG. 3 permits developers to sell multiple virtual items (e.g., shoes, accessories, clothing, etc.) for a set fee and users to buy multiple items for a set fee. In addition to making creation simpler, using this process makes computation faster and reduces resource requirements during creation.

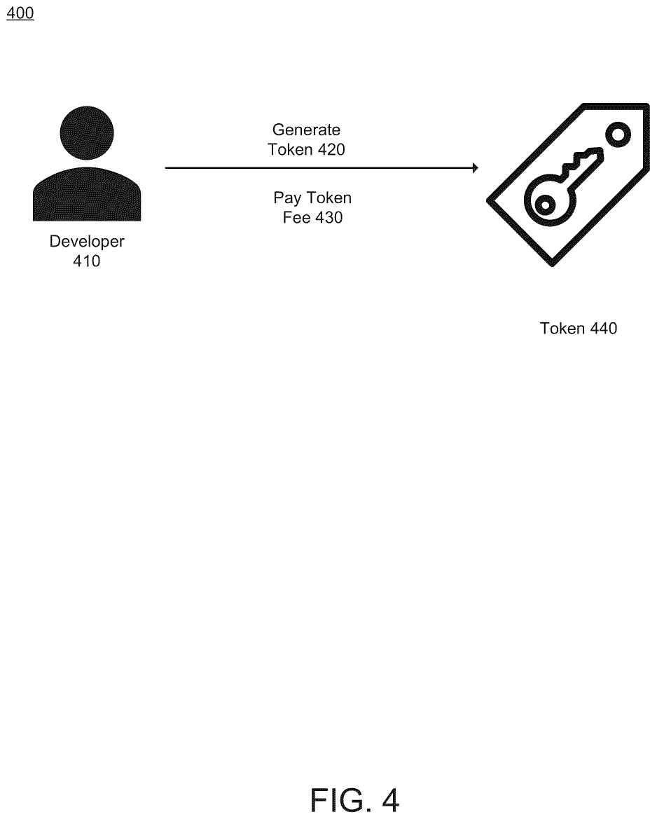

FIG. 4 is a diagram 400 illustrating an example of generating a token, in accordance with some implementations. FIG. 4 illustrates a developer 410. The developer 410 generates the token at 420 and pays the token fee at 430. The result is token 440. Token 440 may be associated with a token identifier (which may be a number, a string, an alphanumeric string as non-limiting examples), used by the virtual environment to reference and use the token 440 to access a modifiable asset and create and manipulate the modifiable asset.

The token 440 may have a token type that is per-product. For example, bodies, pants, and shirts are considered different types. Developers can create different tokens to permit users to create multiple item types. Tokens are not always sellable in a marketplace of the virtual environment. Instead, tokens are purchased directly in experiences, as discussed herein. However, in some implementations, other routes for purchasing tokens may be provided in some implementations.

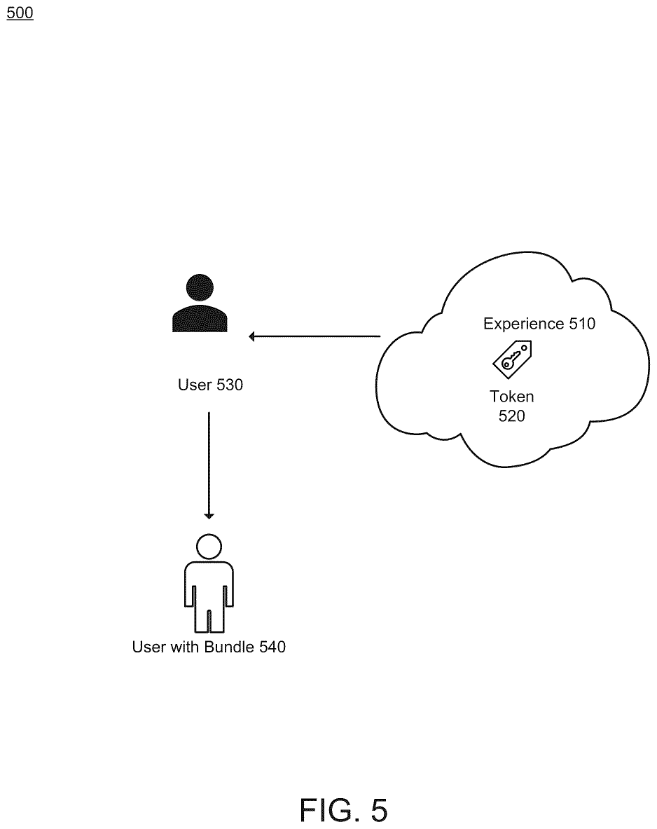

FIG. 5 is a diagram 500 illustrating an example of receiving and using a token, in accordance with some implementations. An experience 510 may be associated with a token 520. The experience 510 provides token 520 to user 530. User 530 is then able to become user with bundle 540, where the token 520 provided to user 530 permits user 530 to become a user with a bundle 540 by managing the bundle associated with the user with the bundle 540.

For example, user 530 may interact with experience 510, purchasing token 520. By purchasing token 520, the user 530 causes experience 510 to provide an identifier for the token 520, where the experience also creates a bundle associated with the token 520 and provides the identifier and the bundle to generate the user with the bundle 540.

The user with the bundle 540 pays the price set previously by the developer, which is greater than or equal to the floor price for bundles (set by the virtual environment). The user 530 is both customer and creator in this case, in that the user 530 purchases the token 520 but the token information permits the user 530 to create variants of the associated modifiable asset. However, due to the nature of the token 520, the variants are usually designated for the use of a particular user 530 (store in inventory, equipped by user 530) in the experience, and are usually not able to be resold in a virtual marketplace.

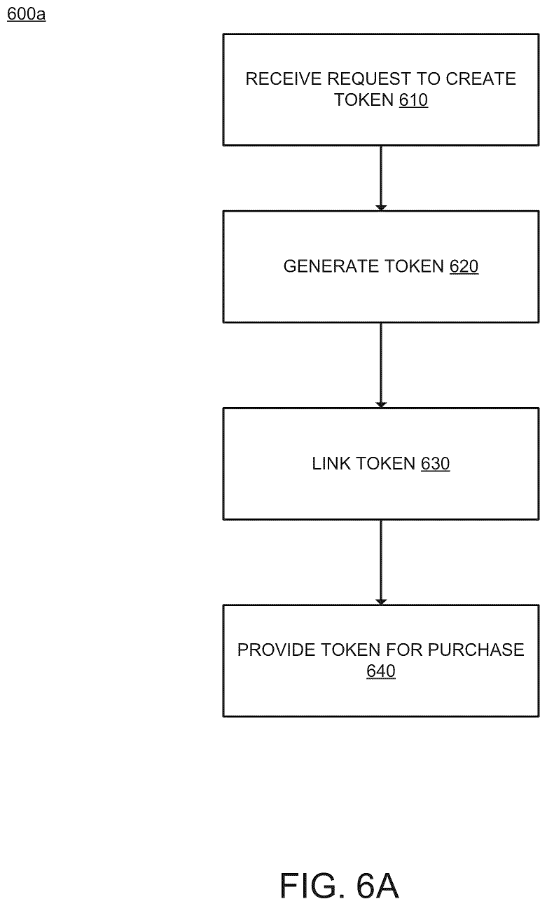

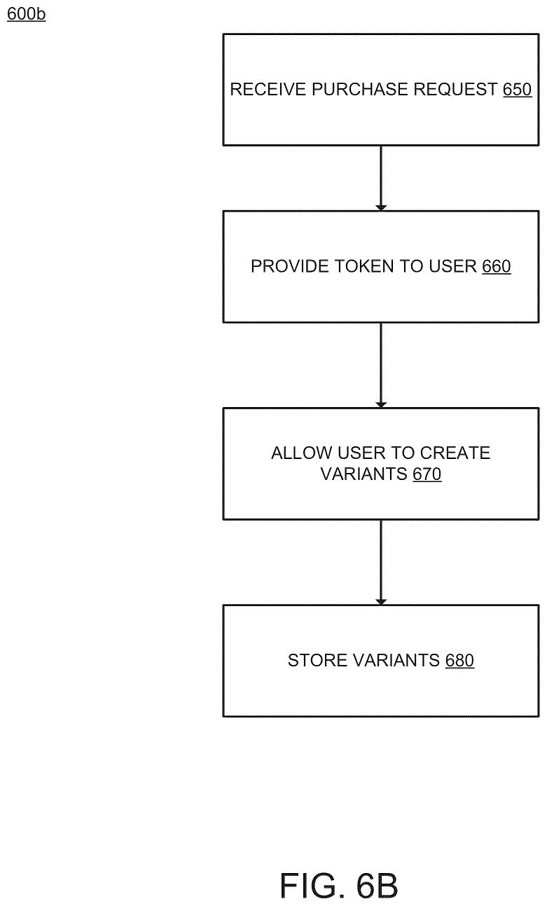

FIG. 6A illustrates a flowchart of an example computer-implemented method 600a to create and provide a token, in accordance with some implementations. Method 600a may begin at block 610.

At block 610, a request to create the token is received. For example, the request may include asset type information and pricing information for the token. The request may be made by a developer that interacts with a virtual environment. The request indicates to the virtual environment that the developer wishes to construct a token to manage a modifiable asset usable in the virtual environment that corresponds to a particular virtual experience. Block 610 may be followed by block 620.

At block 620, the token corresponding to the request is generated. The virtual environment generates the token in response to the request. For example, the token may include a token identifier, a product price that matches the pricing information in the request, and an asset type that matches the asset type information in the request. There may be additional information associated with the token, such as a creator permissions entity that defines what a purchasing user is able to do with the token. Block 620 may be followed by block 630.

At block 630, the token is linked, such as in the virtual experience of the virtual environment. For example, the token is linked using a token identifier that may be a number, a string, or an alphanumeric string and the token identifier provides the ability to reference the token and thereby access the modifiable asset. Block 630 may be followed by block 640.

At block 640, the token is provided for purchase. For example, users of a virtual experience to which the token is linked may purchase the token. After block 640, the initial aspects of providing the token are complete. Block 640 may be followed by block 650, illustrated in FIG. 6B.

FIG. 6B illustrates a flowchart of an example computer-implemented method 600b to sell and provide a token and use the token to create a variant of an asset, in accordance with some implementations. Method 600b may begin at block 650.

At block 650, a purchase request is received. The purchase request may be received from a user in a particular virtual experience for a token provided for sale in that particular virtual experience. The purchase request may also include information that provides a way to transmit funds from the requesting user that pays for the token. As discussed herein, the cost of the token may be set by the developer, though the virtual environment may set a price floor for the purchase of tokens that individual developers are bound to honor. Block 650 may be followed by block 660.

At block 660, the token is provided to the user. For example, the token ID may be provided to the user and this may permit the user to access the token. However, by using the token ID or separate information, the user may have access to other information, such as asset type, access privileges, creation dates, experience information, and so on. Block 660 may be followed by block 670.

At block 670, the user is permitted to create variants of the modifiable asset. For example, the variants may be created by taking the modifiable asset in its original form and then providing a dynamic texture interface (such as a dynamic texture API) or a dynamic mesh interface (such as a dynamic mesh API). As noted, these are examples of interfaces, and other user interfaces may be provided and used to create variants. While producing variants, the asset type does not change (i.e., a shirt cannot be transformed into pants). At this stage, the changes may be temporary, until the changes are actually stored. By allowing creation of variants in this manner, fewer resources (e.g., processing and storage) are used by comparison to creating variants as wholly separate assets. Block 670 may be followed by block 680.

At block 680, the variant of the modifiable asset is stored. The variant may be stored to an inventory of the user who purchased the token. Storing makes changes to the variant permanent and/or persisted. After storing the variant in the inventory of the user, the user may further be provided with an option to equip an avatar associated with the user in the particular virtual experience with the variant of the modifiable asset. For example, if the shape and coloration of a cowboy hat are changed, after such modification the hat may be stored to the corresponding user inventory and the user may be permitted to equip the avatar associated with the user with that modified hat.

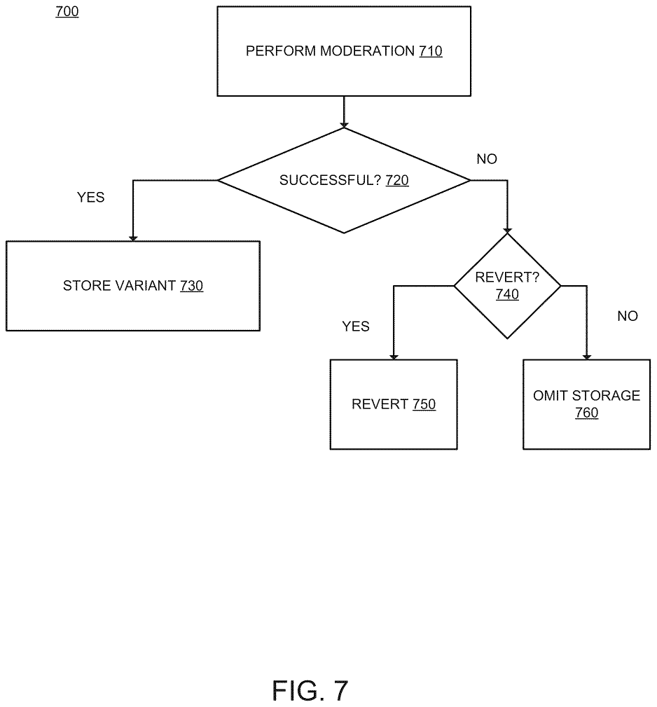

FIG. 7 illustrates a flowchart of an example computer-implemented method 700 to perform moderation on a created asset, in accordance with some implementations. Method 700 may begin at block 710.

At block 710, moderation is performed on a created asset to confirm that the created asset does not violate any policies, such as for inappropriate content or other content policies. For example, the moderation may involve performing a plurality of tests, checks, or analyses on the created asset confirming that it does not violate content policies. For example, the asset could be tested for foul language or offensive graphical elements.

It may also be helpful to use a machine learning (ML) model that may be trained to accurately and automatically perform such moderation. Alternatively, the moderation may be performed by a human moderator. If a human moderator performs moderation, the moderation may be a holistic analysis of the content in which the human moderator decides if any aspect of the content is offensive, inappropriate, or otherwise violates standards of the virtual environment. There may be disparities in the moderation from one virtual experience to another, in that different virtual experiences may use different standards to determine which content is allowable. For example, one virtual experience may have a different target audience than another, and the different standards to be enforced may lead to disparities in the moderation between virtual experiences. Block 710 may be followed by block 720.

At block 720, it is determined if the moderation is successful. If so, block 720 is followed by block 730. If not, block 720 is followed by block 740. In general, moderation is successful if there is no violation of any of the moderation criteria, and if any criterion is violated then moderation is not successful.

At block 730, the variant is stored. It may be possible to generate other variants, which may also involve being moderated, starting at block 710.

At block 740, the moderation is unsuccessful. It is determined how to respond to unsuccessful operation, specifically whether to revert or not. If so, block 740 is followed by block 750. If not, block 740 is followed by block 760.

At block 750, the moderation reverts. That is, instead of applying the change, the asset goes back to its previous version. Even though the change was not successfully stored (due to the unsuccessful moderation), the user may be able to make other changes to the modifiable asset.

At block 760, the moderation omits storage. That is, the asset remains unchanged and the changes made by the user are discarded. Even though the change was not successfully stored (due to the unsuccessful moderation), the user may be able to make other changes to the modifiable asset.

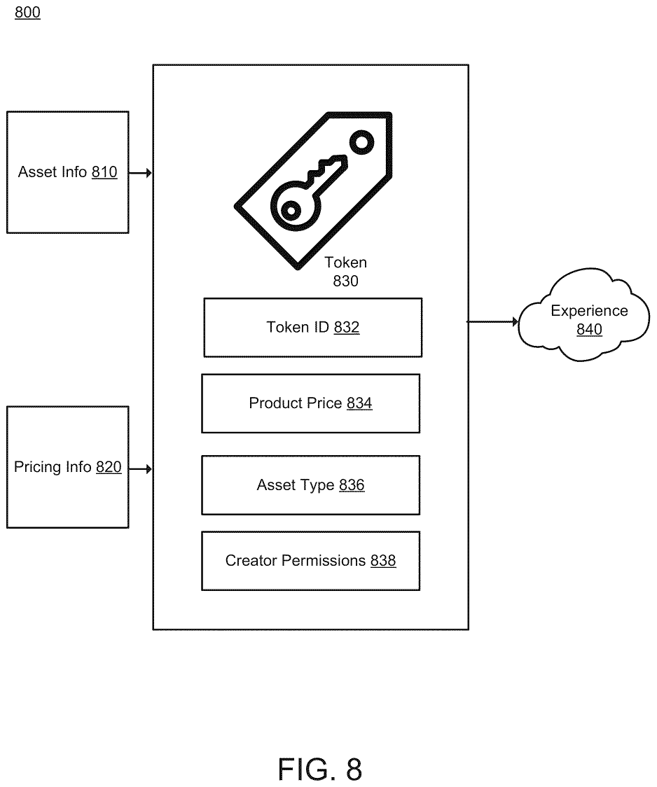

FIG. 8 illustrates a diagram 800 of creating and providing a token in a virtual experience, in accordance with some implementations. The token creation begins by receiving asset information 810 and pricing information 820. This information may be part of an initial request to create a token 830. For example, part of the asset information 810 may be a type of asset to be associated with the token 830. The pricing information 820 may include information about how expensive it is for a user of a given virtual experience to acquire the token 830.

The asset information 810 and the pricing information 820 are provided to generate the token 830. The token 830 includes various information. For example, the token 830 includes a token ID 832, a product price 834, an asset type 836, and creator permissions 838. The token ID 832 is an identifier, such as an alphanumeric string, that is associated with token 830 and permits a developer and/or user to reference the token 830 when using the token 830.

The token 830 also includes a product price 834. The product price 834 is an amount of currency that is charged for a user to purchase the token 830 in a virtual environment. For example, the currency may be an official currency of a nation or group of nations (i.e., U.S. Dollars, European Union Euros, Japanese Yen, etc.), a cryptocurrency, or an in-game currency for the virtual environment.

The token 830 also includes an asset type 836. For example, the asset type 836 may be all or part of an avatar or an accessory for an avatar. For example, the asset type 836 may be one of a body, a shirt, or pants. The token 830 may act as an indicator that a user with access to token 830 has the ability to create additional variants of the asset, as long as the asset type 836 does not itself change. By specifying an asset type 836, it may help establish which aspects of an asset are not to be changed. For example, if asset type 836 corresponds to a humanoid body, the humanoid body may maintain two arms and two legs, even if the humanoid body is not otherwise changed.

The token 830 also includes creator permissions 838. The creator permissions 838 specify which aspects of the modifiable asset the token provides rights to modify. For example, the user may be allowed to modify textures for certain portions of the modifiable asset, or there may be constraints on how much the mesh of the modifiable asset may be deformed.

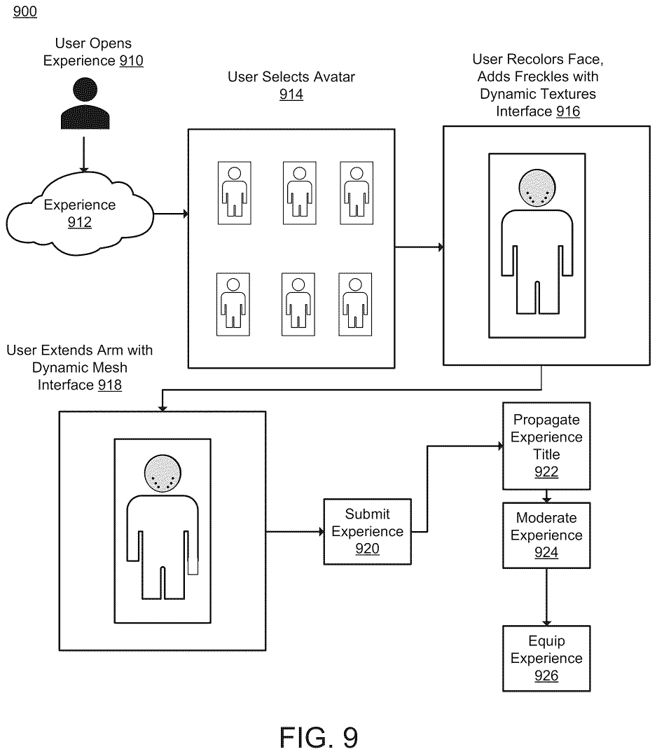

FIG. 9 illustrates a diagram 900 of operations performed by a user to modify and use a modifiable asset, in accordance with some implementations. In FIG. 9, a user 910 opens an experience 912. The experience 912 may provide the user 910 with a selection of avatars, and the user selects an avatar at 914. For example, a virtual experience may be a bodybuilder game. The user 910 may wish to modify a bodybuilder avatar for the user in the virtual experience. As an alternative to selecting avatar at 914, the user 910 may also create the avatar at 914 in other ways, such as by using generative artificial intelligence (AI) techniques.

The avatar selected at 914 is subsequently editable by user 910. For example, at 916, the user recolors the face of the selected avatar. The user may also add freckles to the face of the selected avatar at 916. Such recoloring and addition of freckles may be performed using a dynamic textures interface (such as a dynamic textures application programming interface (API)).

The user may also extend an arm of the avatar using a dynamic mesh interface at 918 (such as a dynamic mesh application programming interface (API)). While using the dynamic texture interface 916 is illustrated as preceding dynamic mesh interface 918, the dynamic texture interface 916 and the dynamic mesh interface 918 may be used repeatedly and in any order to modify assets (until modification is complete). Such interfaces provide an effective way to modify certain aspects of the modifiable asset (e.g., textures and meshes) while maintaining the asset type.

Once an asset is done being modified, the asset is submitted to experience 912 at block 920. When submitting the asset, the asset may be associated with a publishing representation that illustrates information such as pricing and thumbnails of the asset.

The submitted asset may have its title propagated throughout experience 912 at 922. For example, there may be a title for the body, which is then automatically propagated to individual assets that are net-new. For example, if the body builder body is named Cool Charlie, an automatic naming system may be used for any net-new assets, such as Cool Charlie—Head.

Once the title is propagated through the experience, the asset may be published and moderated in the experience 912 at 924. For example, the user taps a publish button or otherwise indicates that an avatar is to be published. The former avatar is illustrated until the former avatar passes moderation. Additional details of the moderation are presented herein.

Once the moderation is successful at 924, the user is provided with an opportunity to equip the asset in the experience at 926. If moderation is unsuccessful, the developer may provide the last state of the avatar the avatar was in before submission. Alternatively, the user can continue to edit and resubmit if the user wishes to do so. The user may be notified about an unsuccessful moderation by a notification from the virtual environment and/or a notification from the experience itself, in an attempt to ensure that the user is aware that modification was not successful.

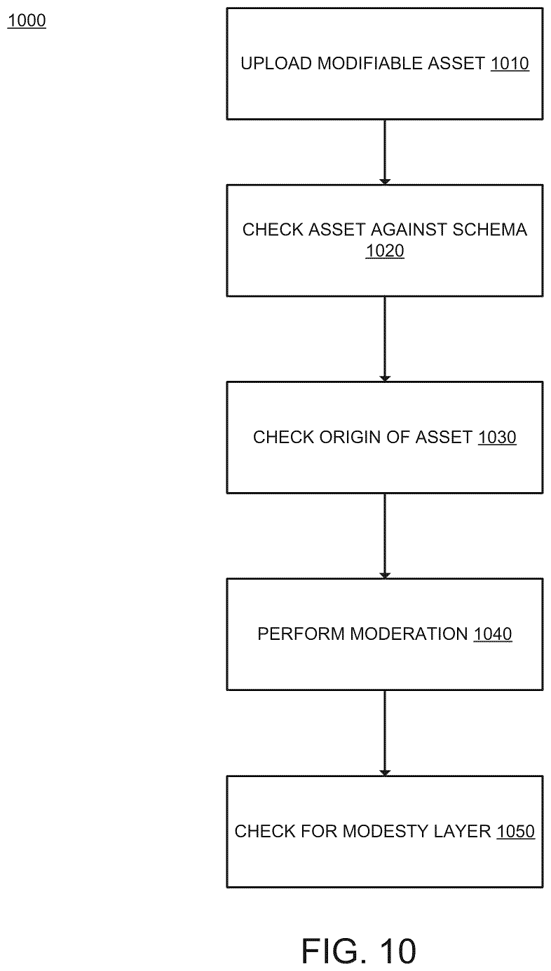

FIG. 10 illustrates a flowchart of an example computer-implemented method 1000 to perform moderation on a created asset, in accordance with some implementations. Method 1000 may begin at block 1010.

At block 1010, a modifiable asset is uploaded. For example, a variant of a modifiable asset created by a user that accesses the modifiable asset with a token may be uploaded. However, prior to use, a moderation process may be involved, which is performed in method 1000, such as at block 1040. Such a moderation process ensures that variants do not have properties that cause them to be unsuitable for use in the virtual experience. Block 1010 may be followed by block 1020.

At block 1020, the asset is checked against a schema. This operation ensures that the asset has appropriate properties and information for the corresponding asset type. Such a schema may be publicly documented and available to developers. By using such a schema, it may be possible to construct a virtual experience so that end users cannot submit schema-invalid content. Block 1020 may be followed by block 1030.

At block 1030, an origin of the asset is confirmed. For example, the content may be permitted to be uploaded if the content was either created in that experience (in that session or previously) or is granted by that experience. For example, there may be rules for what is grantable specifying that, when pushing bundles to inventory in an experience in this new flow, assets in a bundle may be either owned by the virtual environment or the creator of the experience or created newly. If on a marketplace, the assets may be free assets. Block 1030 may be followed by block 1040.

At block 1040, moderation is performed. Specifically, the moderation may moderate the content for safety and civility, among other policies to verify. For example, there may be no initial restrictions on the creation of bodies and faces (as well as other assets). When performing the creation, users may use dynamic textures and dynamic meshes for full free-form pixel and vertex editing. Because there are no constraints built into this stage of the creation process, the content is to be reviewed (i.e., moderated) before the content is exposed in the virtual environment. Every subsequent iteration also involves being moderated. Block 1040 may be followed by block 1050.

At block 1050, a modesty layer is checked for, as defined above. However, this check is optional and may apply to certain avatars where modesty is called for. For example, a modesty layer may be checked for at the bottom torso of an avatar, and/or possibly the upper torso of an avatar. However, if the content in question is not a body or is not a humanoid body, the issue of a modesty layer may be irrelevant. For example, if the body is that of a dog or a horse, a modesty layer may not be applicable.

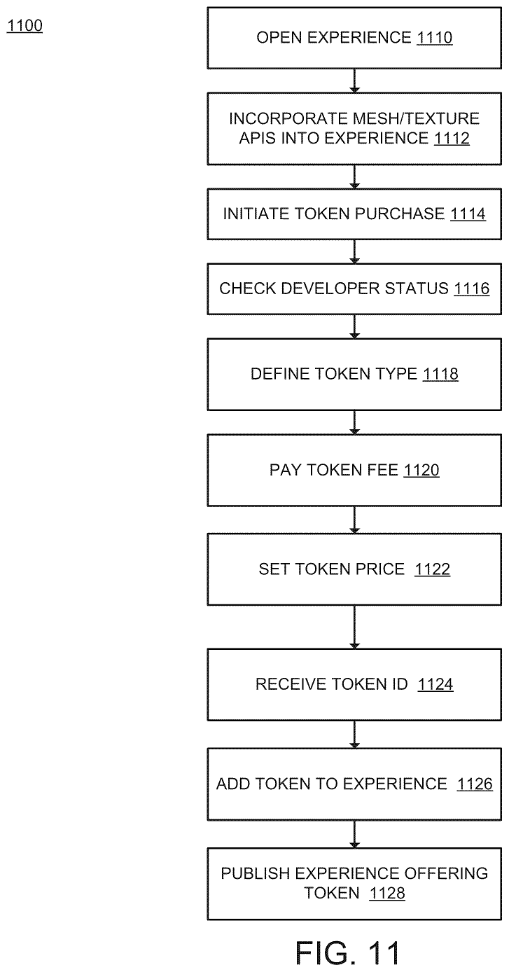

FIG. 11 illustrates a flowchart of an example computer-implemented method 1100 performed by a developer to create and provide a token to manage a modifiable asset, in accordance with some implementations. Method 1100 may begin at block 1110.

At block 1110, an experience is opened. For example, an experience may be the experience Bodybuilder 1977 and a developer may wish to add in-experience creation (IEC) of bodies into that experience. Block 1110 may be followed by block 1112.

At block 1112, mesh and/or texture APIs may be incorporated into an experience. For example, a developer may learn about these APIs and learn that these APIs provide a way for a user to modify a modifiable asset associated with a token. Such APIs use mesh and/or texture manipulation to create variants of the modifiable asset. Block 1112 may be followed by block 1114.

At block 1114, a token purchase is initiated. For example, the developer wants to permit IEC of bodies, so the developer goes to a creator dashboard and starts the process of buying a token at the creator dashboard. Block 1114 may be followed by block 1116.

At block 1116, a developer status is checked. For example, it may be confirmed that a developer has a status with a verified identification. The developer may also be confirmed to have a premium status. Such a verified identification and/or premium status may involve a payment to the virtual environment for the developer to have these status(es) in place. However, other developer statuses may also be used in lieu of verification and/or a paid-for premium status, or the status check may be optional. Block 1116 may be followed by block 1118.

At block 1118, a token type is defined. For example, the developer may indicate that the token type is for Bodies. Block 1118 may be followed by block 1120.

At block 1120, a token fee is paid by the developer. Such a fee is paid by the developer to the virtual environment to permit the virtual environment to monetize the creation of tokens at the point of creation (as opposed to just when tokens are sold to users). The token fee may include a non-recoupable development fee (for example, 750 units of in-game currency) and a recoupable publishing fee (for example, 500 units of in-game currency). Block 1120 may be followed by block 1122.

At block 1122, a price is set for the token. In some implementations, the virtual environment may define a floor price for the token, though the developer may set a higher price for the token. The virtual environment may otherwise constrain the price of the token. The developer can also modify the token price later, such as at the creator dashboard. For example, the floor price of the token may be 250 units of in-game currency, but the developer may choose to set the price of a token the developer creates to 300 units of in-game currency. Block 1122 may be followed by block 1124.

At block 1124, a token ID is received for the token. The token ID permits the developer and the virtual environment to access and sell the token subsequently to users of the specific virtual experience with which the token is associated. Block 1124 may be followed by block 1126.

At block 1126, the token is added to the experience. More specifically, the developer returns to a creation program and provides the token in the virtual experience associated with the developer to permit for in-experience creation (IEC) and pushing to inventory in that virtual experience, when users of the experience buy and use the token. Block 1126 may be followed by block 1128.

At block 1128, the experience offering the token is published. At this point the token is available for purchase by a user. Accordingly, the token can be used by the user thereafter to create variants of a modifiable asset. Users can start creating and publishing bodies (and other modifiable assets, as appropriate) to their respective inventories. Using the token in this manner reduces computations and memory usage during the creating and publishing.

With respect to these transactions, the developer may make a certain portion of sales until the publishing fee is recouped, and then another portion afterwards. For example, if the developer spent 500 units of in-game currency as a recoupable publishing fee, the developer may receive 100% of sales of the token until those 500 units are recouped and then 70% of sales afterwards, with the remainder going to the owners of the virtual environment. However, these are examples and the publishing fee and percentages may vary. Such an arrangement provides the developer and the virtual environment with an improved way to monetize creating assets by making it easier and more profitable to do so, while also utilizing computing resources more effectively.

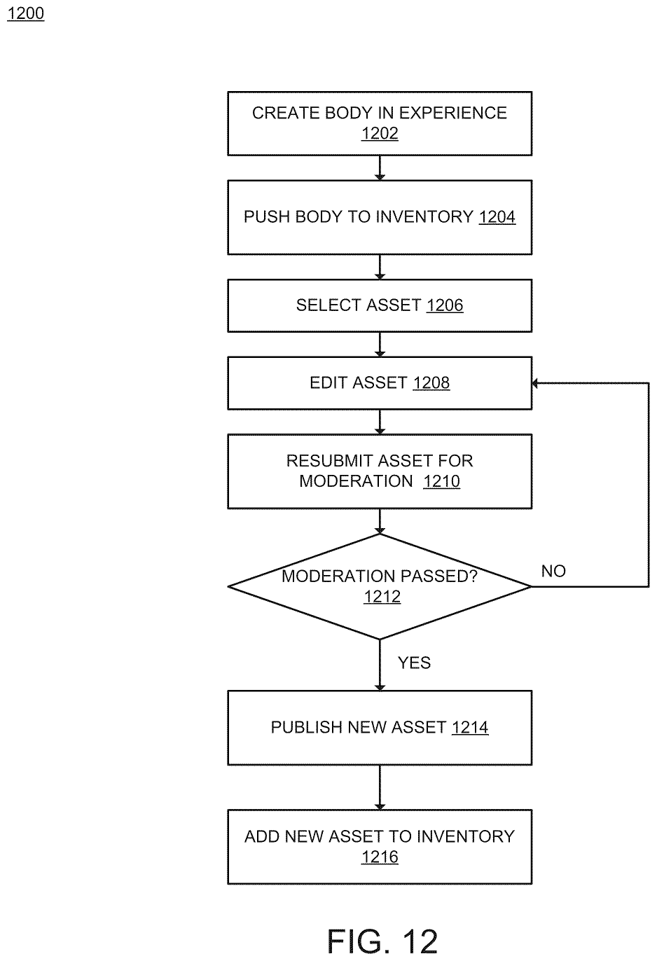

FIG. 12 illustrates a flowchart of an example computer-implemented method 1200 to use a token to manage a modifiable asset, in accordance with some implementations. Creation happens from in-experience and created avatar content retains an attribution link to its experience of origin.

A user may be able to click on this attribution link, return to the experience of origin, return to the editing location within that experience, continue editing any part of their content, and publish these as new assets/outfits back to the virtual experience within the virtual environment. Users may want to make frequent changes to their avatar content. This issue may be helped with inventory clutter by permitting archiving of old assets and/or deletion of bundles. Method 1200 may begin at block 1202.

At block 1202, a body (or another asset) is created in an experience. For example, if the virtual experience is a Body Builder 1977 experience, an example body, an Arnold body, may be created for the user to work with. Block 1202 may be followed by block 1204.

At block 1204, the body is pushed to an inventory. For example, the body in question may be the Arnold body. When pushing this asset to inventory, the asset is visible in inventory along with a corresponding moderation status. After passing moderation, the asset is in the inventory of the user along with an appropriate thumbnail and can be equipped. Block 1204 may be followed by block 1206.

At block 1206, an asset is selected. For example, the user may access their inventory and see an asset. For example, the Arnold body outfit may be in an inventory of the user, linked to the Body Builder 1977 experience by an attribution link. When selecting the asset, the user selects the link, thereby providing access to the creation experience within the virtual experience. Block 1206 may be followed by block 1208.

At block 1208, the selected asset is edited. For example, the selected asset may be edited using a dynamic texture interface, a dynamic mesh interface, or a combination thereof. However, these are examples and other tools may permit the user to edit the selected asset, along with or instead of a dynamic texture interface and/or a dynamic mesh interface.

The editing permits changes to the outside appearance and shape of the selected asset. However, the asset is to retain its asset type and may involve validation and moderation before the asset is actually available for use. For example, a user may use the dynamic mesh interface to make an Arnold Left Arm (i.e., the left arm of the Arnold body) longer by interacting with the mesh to extend the left arm of the avatar body. Block 1208 may be followed by block 1210.

At block 1210, the asset is resubmitted for moderation, based on the changes made to the asset. Block 1210 may be followed by block 1212.

At block 1212, it is determined if the moderation of the asset is passed. If so, block 1212 is followed by block 1214. If not, block 1212 is followed by block 1208. However, if a composite of multiple assets fails moderation, those assets that were not net-new (i.e., previously established assets) may still be granted and/or published at block 1214.

At block 1214, the new asset is published. When publishing, there may be a publication of a new outfit, new asset IDs for any modified assets, and grants of assets that are already avatar assets. Block 1214 may be followed by block 1216.

At block 1216, the new asset is added to the inventory. Accordingly, the user sees the new outfit and underlying assets in the inventory of the user. The old outfit and/or assets of the user are also in the inventory and the user can archive and/or delete the old outfit and/or assets to clean up their inventory (by improving the user interface (UI) and avoiding wasting resources on obsolete information).

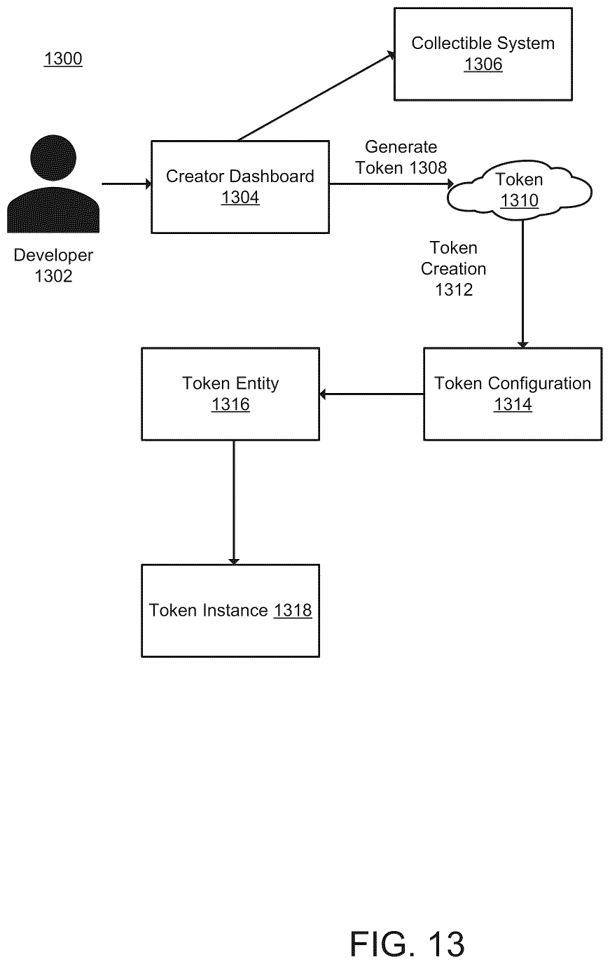

FIG. 13 illustrates a diagram 1300 of operations performed by a developer to create and provide a token and corresponding token instances, in accordance with some implementations. Developer 1302 may be a developer in a virtual environment who creates a token as discussed herein. In order to be permitted to create such a token, developer 1302 may be confirmed to meet one or more conditions. For example, developer 1302 may have a verified ID and/or some level of premium membership. However, other constraints may affect who is eligible to be a developer 1302.

A common implementation of IEC is developers building structured experiences where users can make customizations/edits to avatar items. Conditions for building this kind of experience may be the same as distributing avatar content on a marketplace in the virtual environment.

A developer may receive authorization from the virtual environment to open an avatar content shop in the virtual experience. For example, authorization may be involved for opening a body, shirt, and pant shop. Further, there may be a developer fee for opening such a body, shirt, and pant shop.

Developers from the creator dashboard are going to create authorization tokens that give developers authorization to expose functionality to the users to create specific avatar items with specific economic configuration. Developers declare a user-generated content creation authorization token per experience. Developers than assign a creator facing name and description. Developers also assign an avatar item type (e.g., body, shirt, pants . . . ).

Consumer pricing information is configured (respecting price floors, price localization, etc.) Future economic configuration (e.g., resale, limitations, etc.) are also specified. The developer may also pay a defined price set by the virtual environment based on the economic attributes of the token. The developer may receive an identifier for the token.

Such an identifier may be used in sales/creator transaction reports. The identifier may also be referenced in game at purchase time for pricing, availability, and moderation. At the end, developers purchase a token from the virtual environment that permits them to create a unique avatar item in an experience with a certain economic configuration and create variants of the item. The token (having a unique identifier) registers the economic configuration of the avatar item with the virtual environment and does so in a resource-efficient manner.

Developer 1302 interacts with a creator dashboard 1304 to initiate the token creation process. Additional details of this process are discussed elsewhere in this disclosure. Using the creator dashboard 1304, the developer 1302 generates a token 1310 at 1308. Additionally, developer 1302 sends a payment for the token to the VEP/Collectible system 1306.

The payment is levied by the virtual environment, in that the token can be sold by the developer, so an initial aspect is causing the virtual environment to receive some of the financial benefit from the token upfront, by levying a creation charge. However, in some implementations, creating the token may be free of charge and the virtual environment generates currency from a sale of the token, instead, among other variations.

The token 1310 undergoes token creation 1312, which leads to token configuration 1314. In token configuration 1314, the token 1310 is associated with an asset type. The token 1310 is also associated with a price at which the user is going to consume items (in an experience). It may also be necessary to establish infrastructure to supply the token, as well as integrate appropriate payments. This approach integrates creating/uploading/publishing a token and generating/buying a token into the virtual environment and its interaction with users and developers.

The token configuration 1314 leads to a token entity 1316. The token entity 1316 may include various information about the token, such as a unique token ID, an asset type, a product ID associated with a price, an experience ID with which the token is associated, and optionally a quantity of associated modifiable assets, information about access rules, and a creation date.

The token entity 1316 may define one or more token instance(s) 1318. Each token instance 1318 is a particular instance of token entity 1316. For example, each token instance 1318 may include various information about the instance, such as a token ID specifying a token for that instance, a target ID specifying an ID of the particular token entity 1316, a target type specifying the asset type of the token instance 1318, and a creation date associated with the token instance.

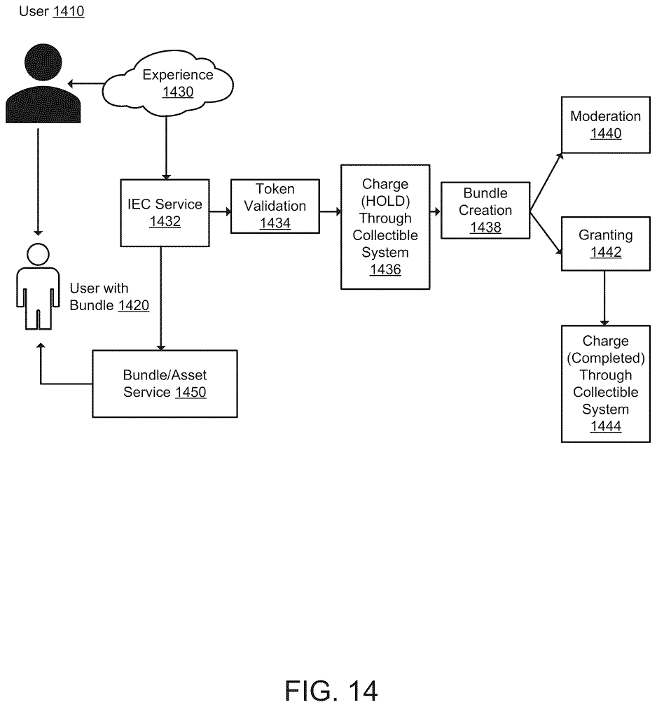

FIG. 14 illustrates a diagram 1400 of operations to provide in-experience creation capabilities, in accordance with some implementations.

For users, in-experience flow may feel like a purchase to the user. For example, a user is creating a net-new bundle that goes through a standard moderation, validation flow. At launch, creations are sent to inventory. In some implementations, a user may not have to be ID-verified (IDV) or a have a premium status. In order to purchase a token, a user may show the same permissions as used when making a purchase on a marketplace for the virtual environment.

Overall, using some implementations is similar to a marketplace purchase for the user (with editing capabilities) and buying a bundle/asset that is available in the inventory of the user and not for sale in a marketplace of the virtual environment. The user creation itself follows a workflow for user-generated content (UGC) as discussed herein, such as the use of tools such as a dynamic texture interface and a dynamic mesh interface to generate such content.

In FIG. 14, an experience 1430 interacts with a user 1410 to manage the creation of a bundle of assets based on using a token for in-experience creation (IEC). The experience 1430 includes an in-experience shop set up by the game developer. The token is used for authorizing access to the modifiable asset and the price at which the user is going to buy. The experience 1430 provides certain information to user 1410.

The experience 1430 also interacts with IEC service 1432. The experience 1430 provides information to the IEC service 1432 such as an array of asset IDs and token IDs, as well as an operation ID, experience ID, developer ID, user ID, and any other necessary parameters to the IEC service 1432. While not explicitly illustrated in FIG. 14, the experience 1430 may also use this information to perform a create bundle operation and a create asset with content attribution, for provision to bundle/asset service 1450.

The IEC service 1432 also performs a token validation at 1434 that establishes that the token is valid. Then, a charge (hold) through a collectible system is performed at 1436. This operation may prepare to charge for using the token. After the charge (hold) operation at 1436, bundle creation occurs at 1438. The bundle goes through moderation at 1440. Once the moderation is successful, a granting occurs in which the bundle is permitted to proceed at 1442. Once the granting occurs, the charge for the bundle is handled by a charge (completed) through a collectible system is performed at 1444.

The IEC service 1432, in addition to the steps using the token described above, uses a bundle/asset service 1450 to finalize the bundle to provide the bundle to create a user with a bundle 1420. The bundle/asset service 1450 may also extend existing publishing approaches. For example, bundle/asset service 1450 may involve modifications that provide for using existing information to store asset ID/bundle ID information, using existing information to identify products, using a token ID to manage the appropriate fees, and blocking publishing to a marketplace and related indexing (the token is local to experience 1430).

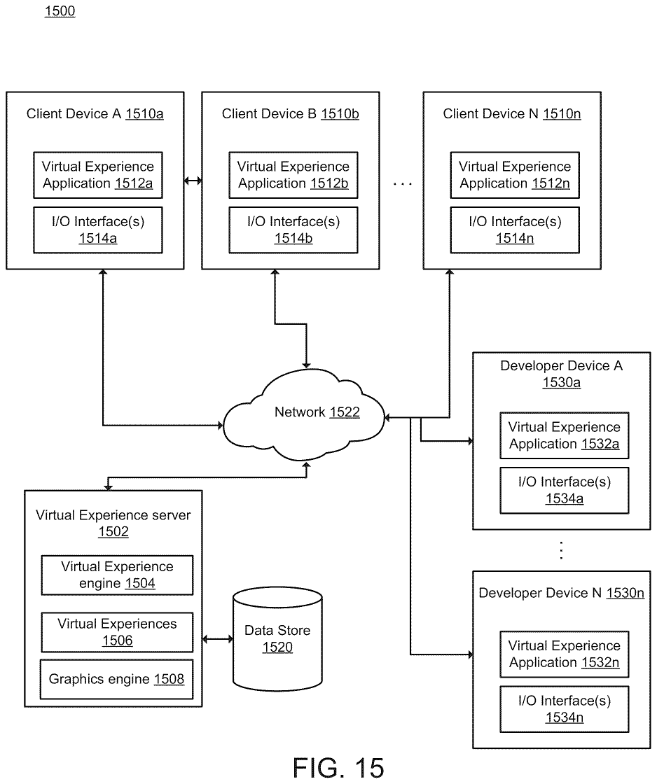

FIG. 15 is a diagram of an example system architecture that provides a token to manage modifiable assets, in accordance with some implementations.

The system architecture 1500 (also referred to as “system” herein) includes online virtual experience server 1502, data store 1520, client devices 1510a, 1510b, and 1510n (generally referred to as “client device(s) 1510” herein), and developer devices 1530 a and 1530 n (generally referred to as “developer device(s) 1530” herein). Virtual experience server 1502, data store 1520, client devices 1510, and developer devices 1530 are coupled via network 1522. In some implementations, client devices(s) 1510 and developer device(s) 1530 may refer to the same or same type of device.

Online virtual experience server 1502 can include, among other things, a virtual experience engine 1504, one or more virtual experiences 1506, and graphics engine 1508. In some implementations, the graphics engine 1508 may be a system, application, or module that permits the online virtual experience server 1502 to provide graphics and animation capability. In some implementations, the graphics engine 1508 and/or virtual experience engine 1504 may perform one or more of the operations described below in connection with the flowcharts shown in FIGS. 6A, 6B, 7, and 10-12. A client device 1510 can include a virtual experience application 1512, and input/output (I/O) interfaces 1514 (e.g., input/output devices). The input/output devices can include one or more of a microphone, speakers, headphones, display device, mouse, keyboard, game controller, touchscreen, virtual reality consoles, etc.

A developer device 1530 can include a virtual experience application 1532, and input/output (I/O) interfaces 1534 (e.g., input/output devices). The input/output devices can include one or more of a microphone, speakers, headphones, display device, mouse, keyboard, game controller, touchscreen, virtual reality consoles, etc.

System architecture 1500 is provided for illustration. In different implementations, the system architecture 1500 may include the same, fewer, more, or different elements configured in the same or different manner as that shown in FIG. 15.

In some implementations, network 1522 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 1520 may be a non-transitory computer readable memory (e.g., random access memory), a cache, a drive (e.g., a hard drive), a flash drive, a database system, or another type of component or device capable of storing data. The data store 1520 may also include multiple storage components (e.g., multiple drives or multiple databases) that may also span multiple computing devices (e.g., multiple server computers). In some implementations, data store 1520 may include cloud-based storage.

In some implementations, the online virtual experience server 1502 can include a server having one or more computing devices (e.g., a cloud computing system, a rackmount server, a server computer, cluster of physical servers, etc.). In some implementations, the online virtual experience server 1502 may be an independent system, may include multiple servers, or be part of another system or server.

In some implementations, the online virtual experience server 1502 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 1502 and to provide a user with access to online virtual experience server 1502. The online virtual experience server 1502 may also include a website (e.g., a web page) or application back-end software that may be used to provide a user with access to content provided by online virtual experience server 1502. For example, users may access online virtual experience server 1502 using the virtual experience application 1512 on client devices 1510.

In some implementations, virtual experience session data are generated via online virtual experience server 1502, virtual experience application 1512, and/or virtual experience application 1532, and are stored in data store 1520. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 1502 may be a type of social network providing connections between users or a type of user-generated content system that allows users (e.g., end-users or consumers) to communicate with other users on the online virtual experience server 1502, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 1520 or within virtual experiences 1506. The data store 1520 may be utilized to store chat transcripts (text, audio, images, etc.) exchanged between participants, with appropriate permissions from the players and in compliance with applicable regulations.

In some implementations, the chat transcripts are generated via virtual experience application 1512 and/or virtual experience application 1532 or and are stored in data store 1520. The chat transcripts may include the chat content and associated metadata, e.g., text content of chat with each message having a corresponding sender and recipient(s); message formatting (e.g., bold, italics, loud, etc.); message timestamps; relative locations of participant avatar(s) within a virtual experience environment, accessories utilized by virtual experience participants, etc. In some implementations, the chat transcripts may include multilingual content, and messages in different languages from different sessions of a virtual experience may be stored in data store 1520.

In some implementations, chat transcripts may be stored in the form of conversations between participants based on the timestamps. In some implementations, the chat transcripts may be stored based on the originator of the message(s).

In some implementations of the disclosure, a “user” may be represented as a single individual. Other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 1502 may be a virtual gaming server. For example, the gaming server may provide single-player or multiplayer games to a community of users that may access as “system” herein) includes online virtual experience server 1502, data store 1520, client or interact with virtual experiences using client devices 1510 via network 1522. In some implementations, virtual experiences (including virtual realms or worlds, virtual games, other computer-simulated environments) may be two-dimensional (2D) virtual experiences, three-dimensional (3D) virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time with other users of the virtual experience.

In some implementations, virtual experience engagement may refer to the interaction of one or more participants using client devices (e.g., 1510) within a virtual experience (e.g., 1506) or the presentation of the interaction on a display or other output device (e.g., 1514) of a client device 1510. For example, virtual experience engagement may include interactions with one or more participants within a virtual experience or the presentation of the interactions on a display of a client device.

In some implementations, a virtual experience 1506 can include an electronic file that can be executed or loaded using software, firmware or hardware configured to present the virtual experience content (e.g., digital media item) to an entity. In some implementations, a virtual experience application 1512 may be executed and a virtual experience 1506 rendered in connection with a virtual experience engine 1504. In some implementations, a virtual experience 1506 may have a common set of rules or common goal, and the environment of a virtual experience 1506 shares the common set of rules or common goal. In some implementations, different virtual experiences may have different rules or goals from one another.

In some implementations, virtual experiences may have one or more environments (also referred to as “virtual experience environments” or “virtual environments” herein) where multiple environments may be linked. An example of an environment may be a three-dimensional (3D) environment. The one or more environments of a virtual experience 1506 may be collectively referred to as a “world” or “virtual experience world” or “gaming world” or “virtual world” or “universe” herein. An example of a world may be a 3D world of a virtual experience 1506. For example, a user may build a virtual environment that is linked to another virtual environment created by another user. A character of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 1502 can host one or more virtual experiences 1506 and can permit users to interact with the virtual experiences 1506 using a virtual experience application 1512 of client devices 1510. Users of the online virtual experience server 1502 may play, create, interact with, or build virtual experiences 1506, communicate with other users, and/or create and build objects (e.g., also referred to as “item(s)” or “virtual experience objects” or “virtual experience item(s)” herein) of virtual experiences 1506.

For example, in generating user-generated virtual items, users may create characters, decoration for the characters, one or more virtual environments for an interactive virtual experience, or build structures used in a virtual experience 1506, among others. In some implementations, users may buy, sell, or trade virtual experience objects, such as in-platform currency (e.g., virtual currency), with other users of the online virtual experience server 1502. In some implementations, online virtual experience server 1502 may transmit virtual experience content to virtual experience applications (e.g., 1512). In some implementations, virtual experience content (also referred to as “content” herein) may refer to any data or software instructions (e.g., virtual experience objects, virtual experience, user information, video, images, commands, media item, etc.) associated with online virtual experience server 1502 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experiences 1506 of the online virtual experience server 1502 or virtual experience applications 1512 of the client devices 1510. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 1502 hosting virtual experiences 1506, is provided for purposes of illustration. In some implementations, online virtual experience server 1502 may host one or more media items that can include communication messages from one user to one or more other users. With user permission and express user consent, the online virtual experience server 1502 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 1506 may be associated with a particular user or a particular group of users (e.g., a private virtual experience), or made widely available to users with access to the online virtual experience server 1502 (e.g., a public virtual experience). In some implementations, where online virtual experience server 1502 associates one or more virtual experiences 1506 with a specific user or group of users, online virtual experience server 1502 may associate the specific user(s) with a virtual experience 1506 using user account information (e.g., a user account identifier such as username and password).

In some implementations, online virtual experience server 1502 or client devices 1510 may include a virtual experience engine 1504 or virtual experience application 1512. In some implementations, virtual experience engine 1504 may be used for the development or execution of virtual experiences 1506. For example, virtual experience engine 1504 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 1504 may generate commands that help compute and render the virtual experience (e.g., rendering commands, collision commands, physics commands, etc.) In some implementations, virtual experience applications 1512 of client devices 1510, respectively, may work independently, in collaboration with virtual experience engine 1504 of online virtual experience server 1502, or a combination of both.

In some implementations, both the online virtual experience server 1502 and client devices 1510 may execute a virtual experience engine/application (1504 and 1512, respectively). The online virtual experience server 1502 using virtual experience engine 1504 may perform some or all the virtual experience engine functions (e.g., generate physics commands, rendering commands, etc.), or offload some or all the virtual experience engine functions to virtual experience engine 1504 of client device 1510. In some implementations, each virtual experience 1506 may have a different ratio between the virtual experience engine functions that are performed on the online virtual experience server 1502 and the virtual experience engine functions that are performed on the client devices 1510. For example, the virtual experience engine 1504 of the online virtual experience server 1502 may be used to generate physics commands in cases where there is a collision between at least two virtual experience objects, while the additional virtual experience engine functionality (e.g., generate rendering commands) may be offloaded to the client device 1510. In some implementations, the ratio of virtual experience engine functions performed on the online virtual experience server 1502 and client device 1510 may be changed (e.g., dynamically) based on virtual experience engagement conditions. For example, if the number of users engaging in a particular virtual experience 1506 exceeds a threshold number, the online virtual experience server 1502 may perform one or more virtual experience engine functions that were previously performed by the client devices 1510.

For example, users may be playing a virtual experience 1506 on client devices 1510, and may send control instructions (e.g., user inputs, such as right, left, up, down, user election, or character position and velocity information, etc.) to the online virtual experience server 1502. Subsequent to receiving control instructions from the client devices 1510, the online virtual experience server 1502 may send experience instructions (e.g., position and velocity information of the characters participating in the group experience or commands, such as rendering commands, collision commands, etc.) to the client devices 1510 based on control instructions. For instance, the online virtual experience server 1502 may perform one or more logical operations (e.g., using virtual experience engine 1504) on the control instructions to generate experience instruction(s) for the client devices 1510. In other instances, online virtual experience server 1502 may pass one or more or the control instructions from one client device 1510 to other client devices (e.g., from client device 1510a to client device 1510b) participating in the virtual experience 1506. The client devices 1510 may use the experience instructions and render the virtual experience for presentation on the displays of client devices 1510.

In some implementations, the control instructions may refer to instructions that are indicative of actions of a user's character within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 1502. In other implementations, the control instructions may be sent from a client device 1510 to another client device (e.g., from client device 1510b to client device 1510n), where the other client device generates experience instructions using the local virtual experience engine 1504. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 1510 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g., shoulder and hip ratio); head size; etc. is provided as illustration. In some implementations, any number of client devices 1510 may be used.

In some implementations, each client device 1510 may include an instance of the virtual experience application 1512, respectively. In one implementation, the virtual experience application 1512 may permit users to use and interact with online virtual experience server 1502, such as control a virtual character in a virtual experience hosted by online virtual experience server 1502, or view or upload content, such as virtual experiences 1506, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to client device 1510 and allows users to interact with online virtual experience server 1502. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application may be an online virtual experience server application for users to build, create, edit, upload content to the online virtual experience server 1502 as well as interact with online virtual experience server 1502 (e.g., engage in virtual experiences 1506 hosted by online virtual experience server 1502). As such, the virtual experience application may be provided to the client device(s) 1510 by the online virtual experience server 1502. In another example, the virtual experience application may be an application that is downloaded from a server.

In some implementations, each developer device 1530 may include an instance of the virtual experience application 1532, respectively. In one implementation, the virtual experience application 1532 may permit a developer user(s) to use and interact with online virtual experience server 1502, such as control a virtual character in a virtual experience hosted by online virtual experience server 1502, or view or upload content, such as virtual experiences 1506, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to developer device 1530 and allows users to interact with online virtual experience server 1502. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application 1532 may be an online virtual experience server application for users to build, create, edit, upload content to the online virtual experience server 1502 as well as interact with online virtual experience server 1502 (e.g., provide and/or engage in virtual experiences 1506 hosted by online virtual experience server 1502). As such, the virtual experience application may be provided to the developer device(s) 1530 by the online virtual experience server 1502. In another example, the virtual experience application 1532 may be an application that is downloaded from a server. Virtual experience application 1532 may be configured to interact with online virtual experience server 1502 and obtain access to user credentials, user currency, etc. for one or more virtual experiences 1506 developed, hosted, or provided by a virtual experience developer.

In some implementations, a user may login to online virtual experience server 1502 via the virtual experience application. The user may access a user account by providing user account information (e.g., username and password) where the user account is associated with one or more characters available to participate in one or more virtual experiences 1506 of online virtual experience server 1502. In some implementations, with appropriate credentials, a virtual experience developer may obtain access to virtual experience virtual objects, such as in-platform currency (e.g., virtual currency), avatars, special powers, accessories, that are owned by or associated with other users.

In general, functions described in one implementation as being performed by the online virtual experience server 1502 can also be performed by the client device(s) 1510, or a server, in other implementations if appropriate. In addition, the functionality attributed to a particular component can be performed by different or multiple components operating together. The online virtual experience server 1502 can also be accessed as a service provided to other systems or devices through suitable application programming interfaces (APIs), and thus is not limited to use in websites.

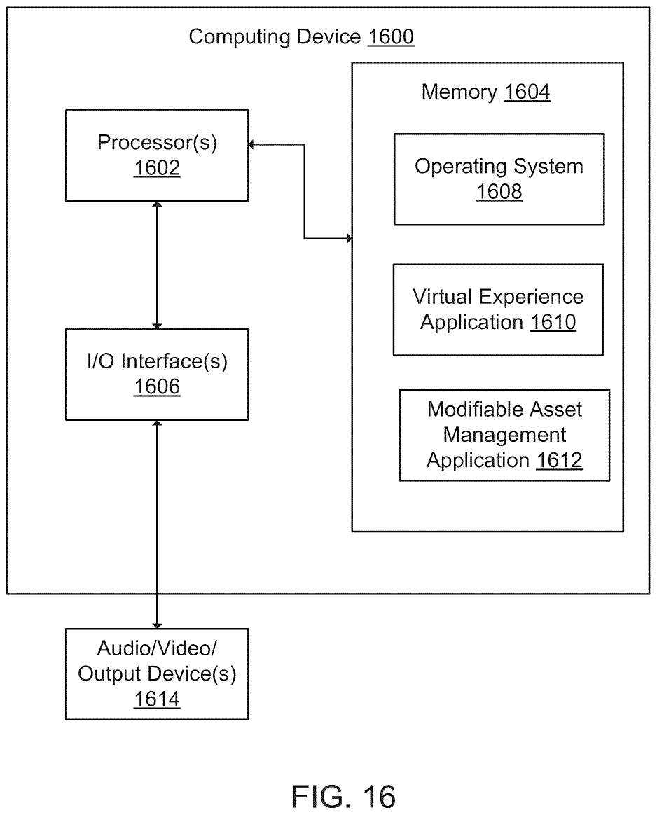

FIG. 16 is a block diagram that illustrates an example computing device 1600 which may be used to implement one or more features described herein, in accordance with some implementations. In one example, computing device 1600 may be used to implement a computer device (e.g., 1502 and/or 1510 of FIG. 15), and perform appropriate method implementations described herein. Computing device 1600 can be any suitable computer system, server, or other electronic or hardware device. For example, the computing device 1600 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, computing device 1600 includes a processor 1602, a memory 1604, input/output (I/O) interfaces 1606, and audio/video input/output devices 1614.

Processor 1602 can be one or more processors and/or processing circuits to execute program code and control basic operations of the computing device 1600. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1604 is typically provided in computing device 1600 for access by the processor 1602, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1602 and/or integrated therewith. Memory 1604 can store software operating on the computing device 1600 by the processor 1602, including an operating system 1608, a virtual experience application 1610, a modifiable asset management application 1612, and other applications (not shown). In some implementations, virtual experience application 1610 and/or modifiable asset management application 1612 can include instructions that enable processor 1602 to perform the functions (or control the functions of) described herein, e.g., some or all of the methods described with respect to FIGS. 6A-6B, 7, and 10-12.

For example, virtual experience application 1610 can include a modifiable asset management application 1612, which as described herein can manage a token that helps provide access to a modifiable asset within an online virtual experience server (e.g., 1502). Elements of software in memory 1604 can alternatively be stored on any other suitable storage location or computer-readable medium. In addition, memory 1604 (and/or other connected storage device(s)) can store instructions and data used in the features described herein. Memory 1604 and any other type of storage (magnetic disk, optical disk, magnetic tape, or other tangible media) can be considered “storage” or “storage devices.”

I/O interface(s) 1606 can provide functions to enable interfacing the computing device 1600 with other systems and devices. For example, network communication devices, storage devices (e.g., memory and/or data store 1520), and input/output devices can communicate via I/O interface(s) 1606. In some implementations, the I/O interface(s) 1606 can connect to interface devices including input devices (keyboard, pointing device, touchscreen, microphone, camera, scanner, etc.) and/or output devices (display device, speaker devices, printer, motor, etc.).

The audio/video input/output devices 1614 can include a user input device (e.g., a mouse, etc.) that can be used to receive user input, a display device (e.g., screen, monitor, etc.) and/or a combined input and display device, that can be used to provide graphical and/or visual output.

For ease of illustration, FIG. 16 shows one block for each of processor 1602, memory 1604, I/O interface(s) 1606, and software blocks of operating system 1608, virtual experience application 1610, and modifiable asset management application 1612. These blocks may represent one or more processors or processing circuitries, operating systems, memories, I/O interfaces, applications, and/or software engines. In other implementations, computing device 1600 may not have all of the components shown and/or may have other elements including other types of elements instead of, or in addition to, those shown herein. While the online virtual experience server 1502 is described as performing operations as described in some implementations herein, any suitable component or combination of components of online virtual experience server 1502 or similar system, or any suitable processor or processors associated with such a system, may perform the operations described.

A user device can also implement and/or be used with features described herein. Example user devices can be computer devices including some similar components as the computing device 1600, e.g., processor(s) 1602, memory 1604, and I/O interface(s) 1606. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 1614, for example, can be connected to (or included in) the computing device 1600 to display images pre-and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., methods 600a, 600b, 700, 1000, 1100, and 1200) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method to create a token that provides access to a modifiable asset usable in a virtual environment, the method comprising:
receiving a request to create the token, the request comprising asset type information and pricing information for the token;
in response to the request, generating the token, the token being associated with a particular virtual experience in the virtual environment, and comprising a token identifier, a product price that matches the pricing information in the request, and an asset type that matches the asset type information in the request;
linking the token with the modifiable asset in the particular virtual experience using the token identifier;
providing the token for purchase in the particular virtual experience;
receiving a purchase request for the token from a user account associated with an avatar in the particular virtual experience;
providing the token to the user account;
allowing a user associated with the user account to create a variant of the modifiable asset usable in the particular virtual experience using a user interface while maintaining the asset type associated with the token, wherein the modifiable asset is accessed using the token identifier; and
storing the variant of the modifiable asset to an inventory of the user account associated with the particular virtual experience, wherein after the storing the variant of the modifiable asset, the user associated with the user account is provided with an option to equip the avatar associated with the user with the variant of the modifiable asset.

2. The computer-implemented method of claim 1, wherein the user interface includes one or both of a dynamic texture interface and a dynamic mesh interface that make temporary modifications to the variant of the modifiable asset and the temporary modifications are made permanent when the variant of the modifiable asset is stored.

3. The computer-implemented method of claim 1, wherein the token is further associated with a creator permissions entity that defines access privileges associated with the token for the user account that makes the purchase request for the token, the access privileges specifying permissions for the user to alter the modifiable asset when creating the variant of the modifiable asset.

4. The computer-implemented method of claim 1, further comprising performing moderation on the variant of the modifiable asset before the variant of the modifiable asset is stored to generate a moderation success or a moderation failure.

5. The computer-implemented method of claim 4, wherein if the moderation failure is generated, the virtual environment reverts to a last state before storage.

6. The computer-implemented method of claim 4, wherein if the moderation failure is generated, storing of the variant of the modifiable asset is omitted.

7. The computer-implemented method of claim 4, wherein storing the variant of the modifiable asset is in response to generating the moderation success.

8. The computer-implemented method of claim 1, further comprising validating the modifiable asset using a schema for the asset type of the token before storing the variant of the modifiable asset.

9. The computer-implemented method of claim 1, wherein allowing the user to create the variant of the modifiable asset comprises permitting the user to create an arbitrary number of variants of the modifiable asset.

10. A non-transitory computer-readable medium with instructions stored thereon that, responsive to execution by a processing device, causes the processing device to perform operations comprising:
receiving a request to create a token that provides access to a modifiable asset usable in a virtual environment, the request comprising asset type information and pricing information for the token;
in response to the request, generating the token, the token being associated with a particular virtual experience in the virtual environment, and comprising a token identifier, a product price that matches the pricing information in the request, and an asset type that matches the asset type information in the request;
linking the token with the modifiable asset in the particular virtual experience using the token identifier;
providing the token for purchase in the particular virtual experience;
receiving a purchase request for the token from a user account associated with an avatar in the particular virtual experience;
providing the token to the user account;
allowing a user associated with the user account to create a variant of the modifiable asset usable in the particular virtual experience using a user interface while maintaining the asset type associated with the token, wherein the modifiable asset is accessed using the token identifier; and
storing the variant of the modifiable asset to an inventory of the user account associated with the particular virtual experience, wherein after the storing the variant of the modifiable asset, the user associated with the user account is provided with an option to equip the avatar associated with the user with the variant of the modifiable asset.

11. The non-transitory computer-readable medium of claim 10, wherein the user interface includes one or both of a dynamic texture interface and a dynamic mesh interface that make temporary modifications to the variant of the modifiable asset and the temporary modifications are made permanent when the variant of the modifiable asset is stored.

12. The non-transitory computer-readable medium of claim 10, wherein the token is further associated with a creator permissions entity that defines access privileges associated with the token for the user account that makes the purchase request for the token, the access privileges specifying permissions for the user to alter the modifiable asset when creating the variant of the modifiable asset.

13. The non-transitory computer-readable medium of claim 10, the instructions cause the processing device to perform further operations comprising performing moderation on the variant of the modifiable asset before the variant of the modifiable asset is stored to generate a moderation success or a moderation failure.

14. The non-transitory computer-readable medium of claim 10, the instructions cause the processing device to perform further operations comprising validating the modifiable asset using a schema for the asset type of the token before storing the variant of the modifiable asset.

15. The non-transitory computer-readable medium of claim 10, wherein allowing the user to create the variant of the modifiable asset comprises permitting the user to create an arbitrary number of variants of the modifiable asset.

16. A system, comprising:
a memory with instructions stored thereon; and
a processing device, coupled to the memory, the processing device configured to access the memory and execute the instructions, wherein the instructions cause the processing device to perform operations comprising:
receiving a request to create a token that provides access to a modifiable asset usable in a virtual environment, the request comprising asset type information and pricing information for the token;
in response to the request, generating the token, the token being associated with a particular virtual experience in the virtual environment, and comprising a token identifier, a product price that matches the pricing information in the request, and an asset type that matches the asset type information in the request;
linking the token with the modifiable asset in the particular virtual experience using the token identifier;
providing the token for purchase in the particular virtual experience;
receiving a purchase request for the token from a user account associated with an avatar in the particular virtual experience;
providing the token to the user account;
allowing a user associated with the user account to create a variant of the modifiable asset usable in the particular virtual experience using a user interface while maintaining the asset type associated with the token, wherein the modifiable asset is accessed using the token identifier; and
storing the variant of the modifiable asset to an inventory of the user account associated with the particular virtual experience, wherein after the storing the variant of the modifiable asset, the user associated with the user account is provided with an option to equip the avatar associated with the user with the variant of the modifiable asset.

17. The system of claim 16, wherein the user interface includes one or both of a dynamic texture interface and a dynamic mesh interface that make temporary modifications to the variant of the modifiable asset and the temporary modifications are made permanent when the variant of the modifiable asset is stored.

18. The system of claim 16, wherein the token is further associated with a creator permissions entity that defines access privileges associated with the token for the user account that makes the purchase request for the token, the access privileges specifying permissions for the user to alter the modifiable asset when creating the variant of the modifiable asset.

19. The system of claim 16, the instructions cause the processing device to perform further operations comprising performing moderation on the variant of the modifiable asset before the variant of the modifiable asset is stored to generate a moderation success or a moderation failure.

20. The system of claim 16, wherein allowing the user to create the variant of the modifiable asset comprises permitting the user to create an arbitrary number of variants of the modifiable asset.
